(19) United States
(12) Patent Application Publication
(10) Pub. No.: US 2026/0158477 A1
(43) Pub. Date: Jun. 11, 2026

(54) 3D Metal, Metal Oxides, And Semiconductor Nanoscale Frameworks Through Templating Of DNA-Programmable Lattice Scaffolds

(71) Applicants: The Trustees of Columbia University in the City of New York, New York, NY (US); Brookhaven Science Associates, LLC, Upton, NY (US); The Research Foundation of the State University of New York, Albany, NY (US)

(72) Inventors: Oleg Gang, New York, NY (US); Aaron Michaelson, West Hempstead, NY (US); Chang Yong Nam, Stony Brook, NY (US); Ashwanth Subramanian, Tualatin, OR (US)

(21) Appl. No.: 18/980,067

(22) Filed: Dec. 13, 2024

Related U.S. Application Data
(60) Provisional application No. 63/610,459, filed on Dec. 15, 2023.

(51) Int. Cl. B01J 29/035; B01J 21/04; B01J 21/06; B01J 23/06; B01J 23/14; B01J 31/06; B01J 31/38; B01J 37/02

(52) U.S. Cl. CPC B01J 29/035; B01J 21/04; B01J 21/063; B01J 23/06; B01J 23/14; B01J 31/061; B01J 31/38; B01J 37/0228; B01J 37/0244

(57) ABSTRACT

A composite, comprising: a three-dimensional (3D) silicate lattice, the silicate lattice comprising a first porous motif, the first porous motif optionally being characterized as polyhedral, the first porous motif optionally defining a pore size of from about 5 to about 100 nm; and a first inorganic layer superposed over the silicate lattice, the first inorganic layer optionally coupled to the silicate lattice. A device, the device comprising a composite according to the present disclosure. A method, comprising: forming a silicate layer superposed on a 3D nucleic acid lattice, the nucleic acid lattice comprising a first porous motif, the first porous motif optionally being characterized as polyhedral, the first porous motif optionally defining a pore size of from about 5 to about 100 nm; and forming a first inorganic layer superposed over the silicate layer, the first inorganic layer optionally coupled to the silicate layer.

### CROSS-REFERENCE TO RELATED APPLICATIONS

This application claims priority to and the benefit of U.S. Provisional Application No. 63/610,459, filed Dec. 15, 2023. All foregoing applications are incorporated herein by reference in their entireties for any and all purposes.

### GOVERNMENT RIGHTS

This invention was made with government support under DE-SC0008772, and DE-SC0012704 awarded by the U.S. Department of Energy, and W911NF-19-1-0395 awarded by the Army Research Laboratory-Army Research Office. The government has certain rights in the invention.

### TECHNICAL FIELD

The present disclosure relates to the field of self-assembling materials and to lattice-structured materials.

### BACKGROUND

Controlling the three-dimensional (3D) nano-architecture of inorganic materials is useful for controlling their novel mechanical, optical, and electronic properties. Accordingly, there is a long-felt need in the art for improved methods of controlling the nano-architecture of inorganic materials. There is a further long-felt need in the art for improved nano-structured inorganic materials.

### SUMMARY

In meeting the described long-felt needs, the present disclosure provides a composite, comprising: a three-dimensional (3D) silicate lattice, the silicate lattice comprising a first porous motif, the first porous motif optionally being characterized as polyhedral, the first porous motif optionally defining a pore size of from about 5 to about 100 nm; and a first inorganic layer superposed over the silicate lattice, the first inorganic layer optionally coupled to the silicate lattice.

Also provided is a device, the device comprising a composite according to the present disclosure.

Further provided is a method, comprising: forming a silicate layer superposed on a 3D nucleic acid lattice, the nucleic acid lattice comprising a first porous motif, the first porous motif optionally being characterized as polyhedral, the first porous motif optionally defining a pore size of from about 5 to about 100 nm; and forming a first inorganic layer superposed over the silicate layer, the first inorganic layer optionally coupled to the silicate layer.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various aspects discussed in the present document. In the drawings:

FIG. 1. Inorganic Templated Structures (A) A silica 3D framework is formed when a lattice of DNA frames is coated with a layer of silica grown via sol-gel synthesis. Templating of the framework is achieved either by (B) Vapor phase infiltration (VPI), where a vapor precursor such as trimethylaluminum (TMA) infiltrates the silica framework or (C) Liquid phase infiltration (LPI) whereby metal salt solutions infiltrate the nanolattice structure. (D) The resultant nanolattice after heat treatment is composed of conformal coatings of silica and metal/metal oxide (MX) on a DNA scaffold. (E) Scanning transmission electronic microscopy (STEM) cross-sectional high-angle annular dark-field (HAADF) imaging and energy dispersive spectroscopy (EDS) map of silica (blue) coated with alumina (purple) via vapor infiltration (scale bar 100 nm).

FIG. 2. Liquid Phase Infiltration (LPI). (A) Schematic of LPI process-after drop-casting of specific concentration of the metal salt solution, silica superlattice is incubated for a variable amount of time, leading to adsorption and deposition of the metal ions on the framework. This was followed by spin-drying and thermal annealing. (B) TEM cross-sectional images of single-element liquid infiltrated silica superlattices coated with specific elements such as copper, molybdenum, platinum, tungsten, indium and tin. Scale bar 50 nm (C) Multi-element incorporation of indium and tin, with the silicon, followed by combined elemental map of indium, and tin, and individual elemental maps of tin, indium, and chlorine. Scale bar 50 nm (D) EDS of chlorine signal before (blue) and after (orange) RTP in oxygen at 600° C., (E) XPS spectra of the binding energy shift of In and Sn 3d5 peaks before (blue) and after (orange) RTP in oxygen. (F) X-ray diffraction spectra after RTP of 50/50 (orange) and 95/5 (blue) indium/tin composition compounds along with a control silica nanolattice. Crystalline peaks for indium tin oxide are shown with black markers.

FIG. 3. Vapor phase infiltration (VPI) (A) Microdosing VPI cycles on a silica superlattice producing nano-templated metal/oxides frameworks. comparing conformal VPI coating with standard ALD that can induce a spurious growth of the precursor. (B) Cross-section TEM of zinc oxide infiltrated nanolattices with cycles (2C-10C, with “C” denoting cycle). At 2C pores (white) can still be seen in the nanostructure reaching into the center of the structure, at 5C the edges are still mostly empty, at 8C and 10C the structure is filled with ZnO as seen from the dark regions filling pores Scale bar 500 nm (C) STEM-HAADF EDS of the 10C superlattice showing the bright area to be rich in Zn and the dark areas to be rich in Si. Scale bar 50 nm.

FIG. 4. Fabrication and characterization of AZO frameworks. (A) TEM and EDS map of 10-cycle VPI of alumina (scale bars are 200 and 50 nm respectively). (B) Mixed TMA cycles and DEZ cycles (cycles alumina: cycles zinc) for three conditions 1:6, 2:5, 3:4, where EDS is used to show the relative amount of alumina versus zinc, (Al in red and Zn in cyan.) Scale bar SEM: 3 μm, HAADF: 50 nm (C) Demonstration of the increased electrical conductivity of the AZO framework compared to the base silica framework by means of an I-V curve along with inset of control silica. Scale bar 5 μm. (D) PL spectra of studied silica, ZnO-silica and Al—ZnO-silica (1:6 and 2:5 Al:Zn) frameworks.

FIG. 5. Composite frameworks via combined VPI and LPI (A) SEM micrograph of VPI/LPI nanostructure of platinum on alumina doped zinc oxide. Scale bar, 1 μm (B) Cross-sectional EDS maps of the structure with channels for platinum, silicon, alumina and zinc. Scale bar, 50 nm (C) High-resolution TEM of pore within framework showing crystalline domains of platinum encircling the interior of the structure along the strut walls. Scale Bar, 10 nm (D) Zoomed out region from panel C, white represents holes in the structure and black is the nanolattice. Scale bar, 20 nm (E) 2D SAXS (left) and WAXS (right) patterns of frameworks deposited on a silicon wafer with corresponding 1D reduction plotting scattering intensity vs wavevector q. Nanoscale (simple cubic) and atomic indexing of diffractions planes are shown, (F) Scanning X-ray nano-tomography of a Pt-AZO superlattice combined phase and fluorescence reconstructions (G) Separate volumetric views of the reconstructed phase and fluorescence (zinc and platinum) of a framework (H) A 2D slice from the central 3D volume of the reconstruction. Scale bar, 100 nm.

FIG. 5. Composite frameworks via combined VPI and LPI (A) SEM micrograph of VPI/LPI nanostructure of platinum on alumina doped zinc oxide. Scale bar, 1 μm (B) Cross-sectional EDS maps of the structure with channels for platinum, silicon, alumina and zinc. Scale bar, 50 nm (C) High-resolution TEM of pore within framework showing crystalline domains of platinum encircling the interior of the structure along the strut walls. Scale Bar, 10 nm (D) Zoomed out region from panel C, white represents holes in the structure and black is the nanolattice. Scale bar, 20 nm (E) 2D SAXS (left) and WAXS (right) patterns of frameworks deposited on a silicon wafer with corresponding 1D reduction plotting scattering intensity vs wavevector q. Nanoscale (simple cubic) and atomic indexing of diffractions planes are shown, (F) Scanning X-ray nano-tomography of a Pt-AZO superlattice combined phase and fluorescence reconstructions (G) Separate volumetric views of the reconstructed phase and fluorescence (zinc and platinum) of a framework (H) A 2D slice from the central 3D volume of the reconstruction. Scale bar, 100 nm.

FIG. 6. X-ray photo spectroscopy (XPS) of Silica Nanolattice. Fitting the Si 2p and O 1S peak shows the substantial presence of Si-Ox and Si—OH group on the surface of the superlattice.

FIG. 7. Surface Modification from Thermal Annealing XPS/STEM Cross section. X-ray spectroscopy investigating pathway of metal oxide attachment via Nitrogen in the superlattice. To assess the possible pathway of nitrogen acting as an anchor for metal attraction to the superlattice three samples were prepared and either left at Room temperature, Heat treated at 600° C., or leveraged rapid temperature processing in oxygen at 600° C. for 5 min. This was to induce more Si—O bonds and remove nitrogen via carbonization of the structure. This was monitored by Nitrogen signal in the superlattice. Rapid temperature processing facilitated the removal of nitrogen however this did not influence the coating of the structure as shown in the accompanying cross sectional eds maps.

FIG. 8. Energy Dispersive Spectroscopy of Platinum Coated Superlattice. Representative SEM of high-resolution regions of superlattices coated with 20 mM Platinum (Na2PtC14 in water) across various times with EDS plotted against each other for 100 k counts; Note that the pores can be seen across all samples indicating the platinum growth did not clog during infiltration, the accompanying Atomic % is listed in the table. The conclusion drawn from this series was that the growth of platinum via liquid infiltration saturates past the 10-min incubation time. Cross sections of 2 min and 5 min are shown in 9.

FIG. 9. STEM cross section of platinum coated superlattice at 2- and 5-minute incubations. Left—2-min infiltration shows higher concentration of Platinum around the periphery of the crystal as compared to Right—5-min incubation with had homogenous platinum signal.

FIG. 10. Au Liquid Infiltration. Gold coating the structure tended to ball up after thermal annealing depositing onto the DNA structure nonspecifically and in-homogenously both when dispersed in (A) water or (B) ethanol which is thought to support more hydrophilic interaction with the surface.

FIG. 11. Platinum liquid infiltration. (A) Representative SEM of platinum infiltrated nanolattices and (B) Cross section STEM/EDS of platinum infiltrated nanolattice at two magnifications, showing the HAADF, and EDS maps of silicon and platinum from the sample.

FIG. 12. Copper Liquid Infiltration. (A) SEM with SEM-EDS of the copper-coated superlattice (B) Cross-section STEM of a copper superlattice with EDS maps of copper nanostructure and some copper which started grain growing in the lower left corner of the structure.

FIG. 13. Molybdenum Liquid Infiltration. (A) SEM and SEM-EDS of Molybdenum coated samples, SEM-EDS map of the superlattice (B) STEM cross-section of the superlattice with EDS maps of the structure.

FIG. 14. Tungsten Liquid Infiltration. (A) SEM and SEM-EDS of Tungsten coated nanolattices (B) STEM cross-section and EDS maps of the structure. We can note a higher concentration of tungsten on the exterior of the sample compared to the interior.

FIG. 15. Tin Liquid Infiltration. (A) SEM-EDS of Tin coated via liquid infiltration to the nanolattice (B) STEM-HAADF and EDS maps of the nanostructure at multiple length scales.

FIG. 16. Indium Liquid Infiltration. (A) SEM-EDS of Indium infiltrated nanolattices (B) STEM-HAADF and SEM EDS maps of the nanostructure at multiple length scales.

FIG. 17. Indium-Tin Mixture Liquid Infiltration. (A) SEM and EDS of Indium-Tin simultaneous liquid infiltration (B) STEM HAADF EDS maps of the Sn—In on silica nanostructure.

FIG. 18. RTP vs Heat treatment for retaining composition. Area integration of tin and indium peaks for a 50/50 composition of indium/tin liquid solution followed by either rapid temperature processing (left) or thermal annealing in air (right) which resulted in a 70/30 mixture of indium tin vs a 56/43 composition under rapid temperature processing.

FIG. 19. XPS of Indium/Tin oxide superlattice. Heat treated (250° C.) Yellow/Green and RTP Blue/Red with an accompanying table with the measured and NIST reported values for Indium and Tin 3d 3/2 and 3d 5/2 orbitals.

FIG. 20. RTP In—Sn-Silica Superlattice STEM Cross Section. High-Resolution STEM microscopy of Indium tin oxide nanoparticle grains after RTP processing. (Top) Low and high magnification of crystalline domain, (Bottom Left-to-Right) Additional STEM of a larger domain, high-resolution magnification image, fast Fourier transform (FFT) of domain, Inverse FFT from masked first order peak, from the inv-FFT multiple layers were measured which is most closely related to (222) InSnOx peak, the deviation makes it difficult to exactly suggest a specific crystal type.

FIG. 21. ALD of Titanium. Standard ALD which results in titanium only on the exterior.

FIG. 22. VPI of Non-porous superlattice. VPI of alumina on a fully filled silica lattice results in elemental deposition only on the exterior of the samples.

FIG. 23. ZnOx Vapor phase infiltration. (Top) SEM-EDS of the silica-zinc framework and with electron microscopy followed by EDS spectrum with Zn-L, Si—K, and O—K peaks identified for both regions (on Sample-spectrum 6, on substrate-Spectrum 7). (Bottom) STEM HAADF-EDS images of Silica coated with Zinc via vapor infiltration, shown is clockwise: HAADF image, HAADF with overlaid Silicon and Zinc Channels, Silicon channel and zinc channel.

FIG. 24. Additional Cross section of VPI Cycles of ZnO. (Clockwise) TEM microscopy of 2 Cycles, 5 cycles and 8 cycles infiltration of DEZ into the superlattice. 2C shows the least amount of full filling (note the white background seen through the pores of the structure.

FIG. 25. Film Thickness from EDS Map of Al coated silica nanolattice. From the elemental map, the aluminum coats approximately 4-6 nm of the superlattice evaluated from the green vs. blue coverage of the links between DNA frames.

FIG. 26. Aluminum Vapor phase infiltration. (Left) STEM HAADF and EDS maps of aluminum infiltrated silica nanolattices nanostructure. (Right) SEM-EDS of the aluminum coated nanolattice with eds spectrum below.

FIG. 27. SEM-EDS of xAlumina-yZinc-Silica Superlattice via vapor infiltration. (Left) SEM/EDS spots of crystals templated to 1A1-6Zn (Octahedron), 2A1-5Zn, and 3Al-4Zn. (Right-Top) EDS comparing all alumina or all zinc vapor phase infiltration (Right-Bottom) EDS spectra of three compositions Al—Zn superlattices. Note: The SEM for 2A1-5Zn shown is of a tetrahedron assembly, the comparison of eds shown was taken across octahedron.

FIG. 28. Cross Sections of Alumina Zinc Superlattice. Additional Cross sections of xAl-yZn-Silica superlattices.

FIG. 29. Additional STEM-EDS Maps of Al—Zn-Silica Superlattice. Additional Cross sections of xAl-yZn-Silica superlattices

FIG. 30. AZO Infiltration to Octahedron and Tetrahedron based lattices. Left images correspond to octahedron and tetrahedron assemblies coated with silica that were subsequently exposed to 1 cycle of TMA and 6 cycles of DEZ. On the Right are images of octahedron and tetrahedron coated with silica and 2 cycles of TMA and 5 cycles of DEZ.

FIG. 31. Additional SEM and SEM-EDS of Pt-AZO-silica Superlattice. Nanolattices are first metalized with VPI of Aluminum and zinc, this was followed by LPI infiltration of Platinum metal salt, and finally thermally annealed.

FIG. 32. AZO-Pt-Silica Superlattice SEM-EDS. Nanolattice were first coated with LPI platinum followed by VPI Alumina Zinc.

FIG. 33. EM Cross-section of Pt-AZO-Silica Superlattice. TEM and HAADF STEM cross section images of VPI Aluminum Zinc followed by LPI platinum. SAED Diffraction and Cropped pattern with annotated rings which correlate to crystalline ZnO.

FIG. 34 Tomography Preparation—Pt-AZO sample. A nanolattice of LPI (Platinum) after VPI (Alumina Zinc) Clockwise: Initial crystal mounted to pin, Fib shaped high magnification image, low magnification of crystal used for tomography.

FIG. 35 Scanning Hard X-ray Microscopy. Scanning hard x-ray microscopy allows for visualization of the 3D distribution of elements throughout the nanolattice. Typically elemental fluorescence maps are collected simultaneously to far field projections which is used to reconstruct the phase image of the sample. Together we can use the high-resolution phase reconstruction and the lower resolution fluorescence to achieve a higher resolution fluorescence using the recovered point spread function from the ptychography reconstruction of the phase. Above select X-ray microscopy projections from a tomographic series are shown and the result from deconvolution of fluorescence with the ptychography reconstructed probe next to the phase reconstruction. Angles −50 and −56 are shown as representative image projects. At −50 degrees the raw zinc and platinum fluorescence maps are shown along with the reconstructed point spread function. The bottom row shows the result of the deconvoluted fluorescence maps using the point spread function alongside the ptychography phase reconstructed projection of the far field signal. At −56 degrees the deconvoluted platinum fluorescence is shown on top and on the bottom row the phase reconstructed projection is shown. Deconvolved fluorescence was used for subsequent 3D reconstruction.

FIG. 36 Tomography—XY slice comparison and ROI from Reconstructed Volume. (Left) The XY central slice of the phase and two fluorescence reconstructions from zinc and platinum. The slices demonstrate the recovery of the spatial elemental distribution within the sample when compared to the high-resolution phase reconstruction. (Right) The full reconstructed volume and the region of interest in red which was used for subsequent visualization.

### DETAILED DESCRIPTION OF ILLUSTRATIVE EMBODIMENTS

The present disclosure may be understood more readily by reference to the following detailed description of desired embodiments and the examples included therein.

Unless otherwise defined, all technical and scientific terms used herein have the same meaning as commonly understood by one of ordinary skill in the art. In case of conflict, the present document, including definitions, will control. Preferred methods and materials are described below, although methods and materials similar or equivalent to those described herein can be used in practice or testing. All publications, patent applications, patents and other references mentioned herein are incorporated by reference in their entirety. The materials, methods, and examples disclosed herein are illustrative only and not intended to be limiting.

The singular forms “a,” “an,” and “the” include plural referents unless the context clearly dictates otherwise.

As used in the specification and in the claims, the term “comprising” can include the embodiments “consisting of” and “consisting essentially of.” The terms “comprise(s),” “include(s),” “having,” “has,” “can,” “contain(s),” and variants thereof, as used herein, are intended to be open-ended transitional phrases, terms, or words that require the presence of the named ingredients/steps and permit the presence of other ingredients/steps. However, such description should be construed as also describing compositions or processes as “consisting of” and “consisting essentially of” the enumerated ingredients/steps, which allows the presence of only the named ingredients/steps, along with any impurities that might result therefrom, and excludes other ingredients/steps.

As used herein, the terms “about” and “at or about” mean that the amount or value in question can be the value designated some other value approximately or about the same. It is generally understood, as used herein, that it is the nominal value indicated ±10% variation unless otherwise indicated or inferred. The term is intended to convey that similar values promote equivalent results or effects recited in the claims. That is, it is understood that amounts, sizes, formulations, parameters, and other quantities and characteristics are not and need not be exact, but can be approximate and/or larger or smaller, as desired, reflecting tolerances, conversion factors, rounding off, measurement error and the like, and other factors known to those of skill in the art. In general, an amount, size, formulation, parameter or other quantity or characteristic is “about” or “approximate” whether or not expressly stated to be such. It is understood that where “about” is used before a quantitative value, the parameter also includes the specific quantitative value itself, unless specifically stated otherwise.

Unless indicated to the contrary, the numerical values should be understood to include numerical values which are the same when reduced to the same number of significant figures and numerical values which differ from the stated value by less than the experimental error of conventional measurement technique of the type described in the present application to determine the value.

All ranges disclosed herein are inclusive of the recited endpoint and independently of the endpoints. The endpoints of the ranges and any values disclosed herein are not limited to the precise range or value; they are sufficiently imprecise to include values approximating these ranges and/or values.

As used herein, approximating language can be applied to modify any quantitative representation that can vary without resulting in a change in the basic function to which it is related. Accordingly, a value modified by a term or terms, such as “about” and “substantially,” may not be limited to the precise value specified, in some cases. In at least some instances, the approximating language can correspond to the precision of an instrument for measuring the value. The modifier “about” should also be considered as disclosing the range defined by the absolute values of the two endpoints. For example, the expression “from about 2 to about 4” also discloses the range “from 2 to 4.” The term “about” can refer to plus or minus 10% of the indicated number. For example, “about 10%” can indicate a range of 9% to 11%, and “about 1” can mean from 0.9-1.1. Other meanings of “about” can be apparent from the context, such as rounding off, so, for example “about 1” can also mean from 0.5 to 1.4.

Further, the term “comprising” should be understood as having its open-ended meaning of “including,” but the term also includes the closed meaning of the term “consisting.” For example, a composition that comprises components A and B can be a composition that includes A, B, and other components, but can also be a composition made of A and B only. Any documents cited herein are incorporated by reference in their entireties for any and all purposes.

Any embodiment or aspect provided herein is illustrative only and does not limit the scope of the present disclosure or the appended claims. Any part or parts of any one or more embodiments or aspects can be combined with any part or parts of any one or more other embodiments or aspects.

Controlling the three-dimensional (3D) nano-architecture of inorganic materials is imperative for enabling their novel mechanical, optical, and electronic properties. Here, by exploiting DNA-programmable assembly, we establish a general approach for realizing designed 3D-ordered inorganic frameworks. Through inorganic templating of DNA frameworks by liquid- and vapor-phase infiltrations, we demonstrate successful nanofabrication of diverse classes of inorganic frameworks from metal, metal oxide and semiconductor materials, and their combinations, including Zn, Al, Cu, Mo, W, In, Sn, Pt and composites such as aluminum doped zinc oxide, indium tin oxide and platinum/aluminum doped zinc oxide. The open 3D frameworks have features on the order of nanometers with architecture prescribed by the DNA frames and self-assembled lattice. Structural and spectroscopic studies reveal the composition and organization of diverse inorganic frameworks, as well as the optoelectronic properties of selected materials.

Modern technological advances in electronics, photonics, and sensing rely heavily on planar fabrication approaches offered by top-down lithographic methods. However, a broad range of emerging applications in optical and mechanical metamaterials, neuromorphic computing and energy materials require three-dimensional (3D) framework organization with complex material compositions and controllable nanoscale architecture. Additive manufacturing provides a route for fabricating 3D structured metals at the microscale.

At the nanoscale, multi-step planar lithography and deposition methods have demonstrated a structural control with a resolution extending to ˜30-100 nm. The technique, however, faces challenges of incorporating a broad class of materials as well as the effort-intensive and low-throughput fabrication of 3D architecture in the sub-30 nm range. On the other side, self-assembly approaches using surfactants, polymers and biomolecules, and shaped nanoparticles offer a rich structural diversity in 3D that can be combined with inorganic templating, which allows for fabrication parallelization. However, these approaches typically do not offer ways to prescribe specific nanoscale architecture and the breadth of material systems is limited.

DNA-based assembly methods have the ability to precisely place inorganic and biological nano-objects according to the designed parameters of the desired structures. For example, DNA origami, due to its shape and interaction programmability as well as size matching with nano-objects, represents a versatile approach for rational generation of diverse structural motifs that can be self-assembled in larger-scale spatially organized 3D frameworks consisting of optical, magnetic, bio-active nano-objects. However, to exploit these 3D DNA-based nanomaterials, robustness and specific functionality are typically required. Converting these 3D frameworks into inorganic architectures might introduce the framework complexity to inorganic materials.

A DNA metallization through the adsorption of ions on a charged DNA backbone was extensively investigated for potential use in molecular electronics. However, this approach typically results in nucleation and unconstrained growth. Recent advances in the silication of complex DNA architectures expanded the potential use of DNA-assembled materials to applications requiring robustness against temperature, environmental factors, and radiation. Concerning material diversity, DNA was shown to template biologically inspired calcium phosphate growth, and processing of silica into silicon carbide was demonstrated for DNA frameworks, providing feasibility of creating a wide bandgap semiconductor. To enable a broad range of applications, these silica-based frameworks can be utilized as architected 3D supports to host other functionally active material coatings.

To overcome existing limitations and to establish a broadly applicable platform for creating 3D frameworks of different classes of materials, a universal strategy for 3D inorganic templating is needed. Ex-situ organic-inorganic hybridization techniques, including liquid-phase infiltration (LPI) and vapor-phase infiltration (VPI), are emerging as new methods for converting polymer templates into functional organic-inorganic hybrids and creating inorganic nanostructures. They have proved useful in not only improving polymer properties, such as etch resistance, rheological and mechanical responses, and optical properties, but also in the patterning of electronic devices. The infiltration techniques have also been shown valuable for creating a library of metals and metal oxides within polymeric structures. Given the structural designability of DNA-based nanomaterials, it is advantageous to employ infiltration-driven hybridization processes to 3D DNA structures to convert them into organic-inorganic hybrids and inorganic nano-replicas.

Here we demonstrate the application of LPI and VPI for inorganic templating of large-scale DNA frameworks. The 3D templating, thus realized, allows us to achieve deep penetration into 3D nano-architectures and to apply these methods, separately or together, to form different functional metal and metal oxide frameworks based on the designed DNA scaffold frameworks. Sol-gel growth of silica followed by the infiltration synthesis provides versatile and modular control over the spatial distribution and elemental composition of inorganic material incorporated into a framework superlattice. The incorporation of single-element and multi-element coatings by exploiting LPI or VPI techniques, or their combination, preserves the underlying DNA lattice architecture while enabling a nanofabrication of 3D inorganic nanoscale frameworks.

### Results/Discussion

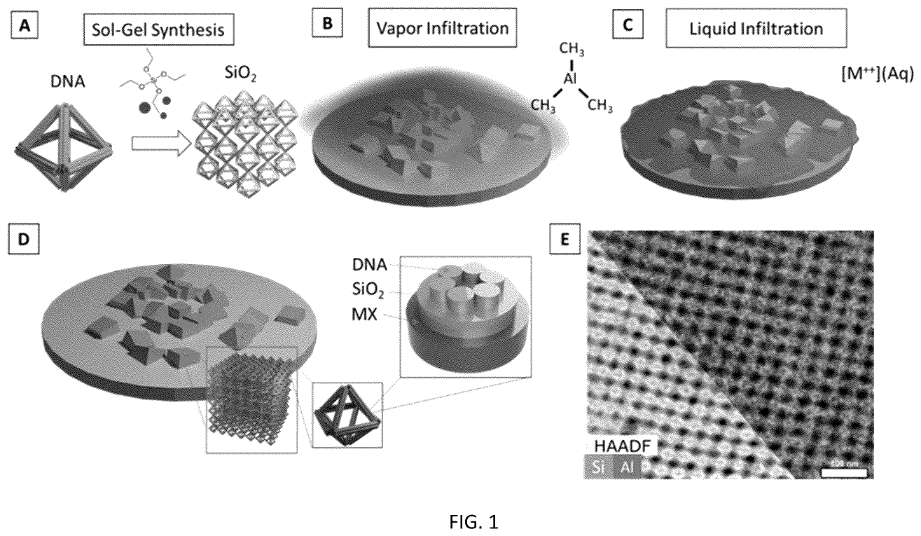

Formation of a DNA superlattice framework starts with synthesizing the DNA origami precursors. DNA origami frames can be formed from the folding of a long scaffold strand of M13 phage DNA with many short synthetic strands of complementary DNA. As an example, we synthesize both octahedral (edge length ˜29 nm) and tetrahedral (edge length ˜36 nm) motifs for the self-assembly of superlattices. Following synthesis of the origami precursor, the DNA frames with complementary binding strands, placed at their vertices, were mixed together and annealed from 50° C. to room temperature at a rate of −0.2° C./hr to form 3D DNA frameworks. Sol-gel wet chemistry was used to grow a 4-10 nm thick layer of silica on the DNA bundles of each type of framework, see FIG. 1A, thus forming silica replica of the DNA framework. The two different motifs result in two pore sizes, approximately 50-60 nm for tetrahedron and 10-20 nm for octahedral assembles. For most work described the octahedral motif is used, in select cases both tetrahedral and octahedral motifs were used as non-limiting, illustrative examples.

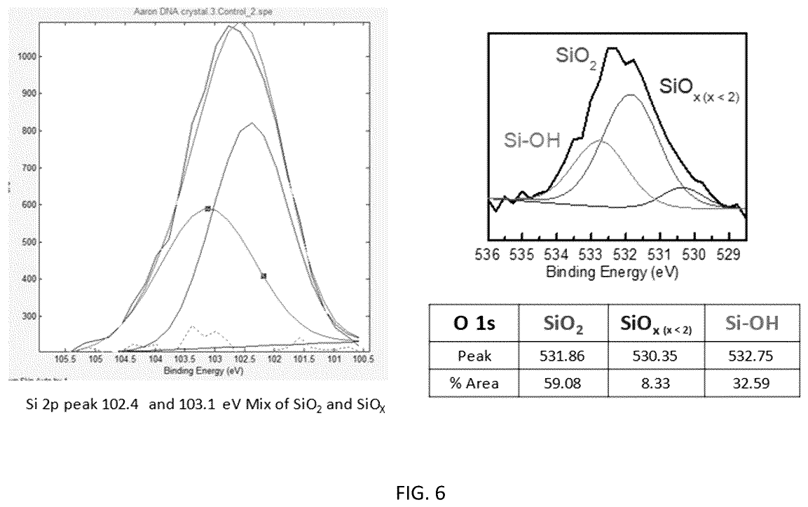

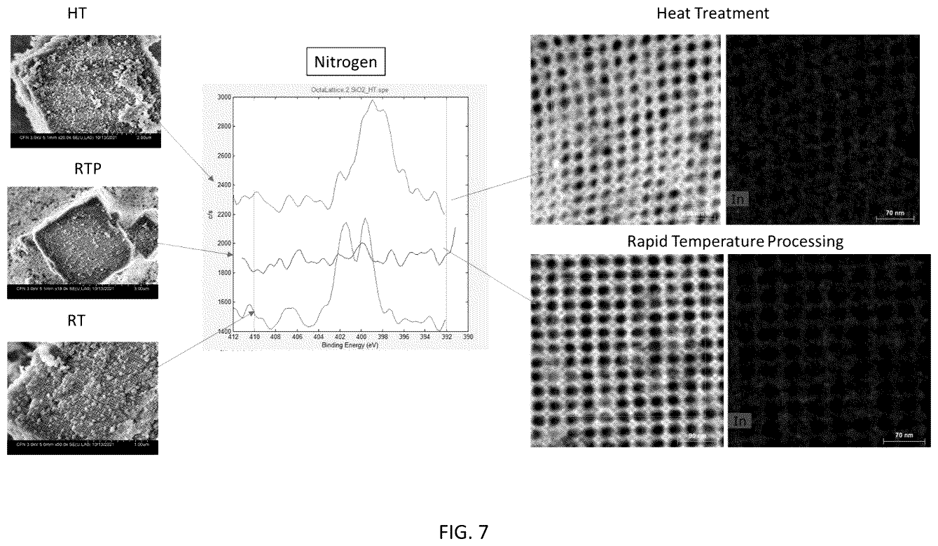

Active sites with —OH groups in the formed silica network of DNA-prescribed framework replica can be directly coupled with the application of VPI (FIG. 1B) and LPI (FIG. 1C) for inorganic templating. In these processes, vapor- or liquid-phase precursors are attracted and bound to the surface —Si or —OH group, yielding precise surface coating of target materials on the silica framework (See FIGS. 6 and 7). Furthermore, the pore structure of the frameworks (pore size ˜10-20 nm) lends itself well to applying LPI and VPI by allowing unhindered transport of precursors into the interior of the silica origami framework. The resultant nanostructure has conformal coatings of metals infiltrated via VPI and/or LPI techniques shown in FIGS. 1D and 1E, demonstrating the metal coating onto the interior pore surfaces within the silica/DNA nanostructure.

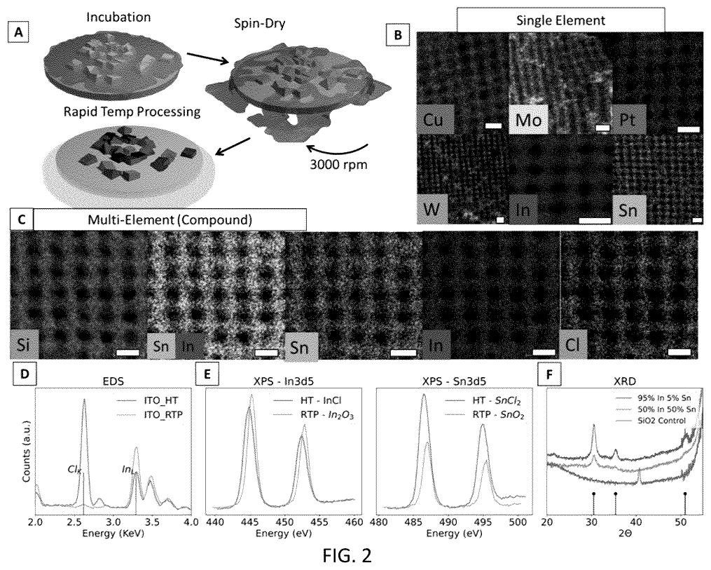

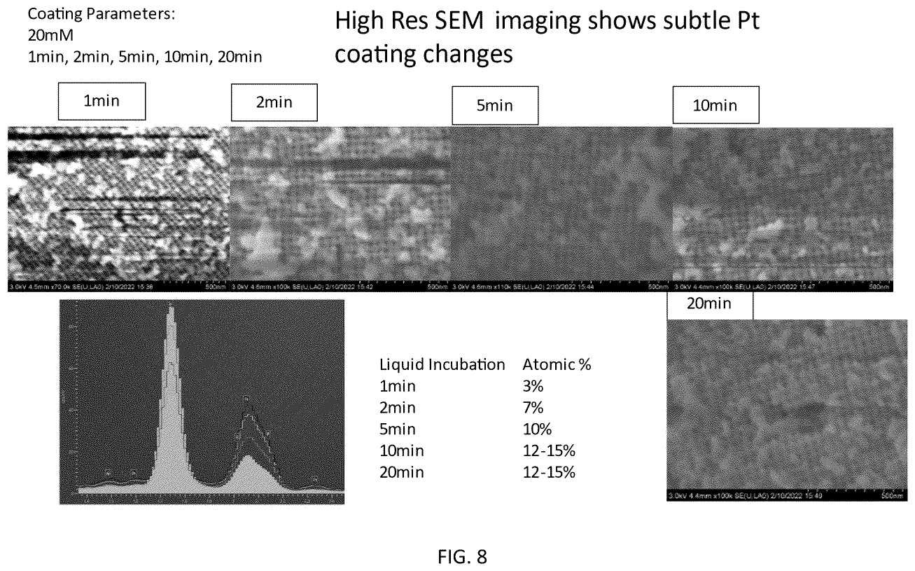

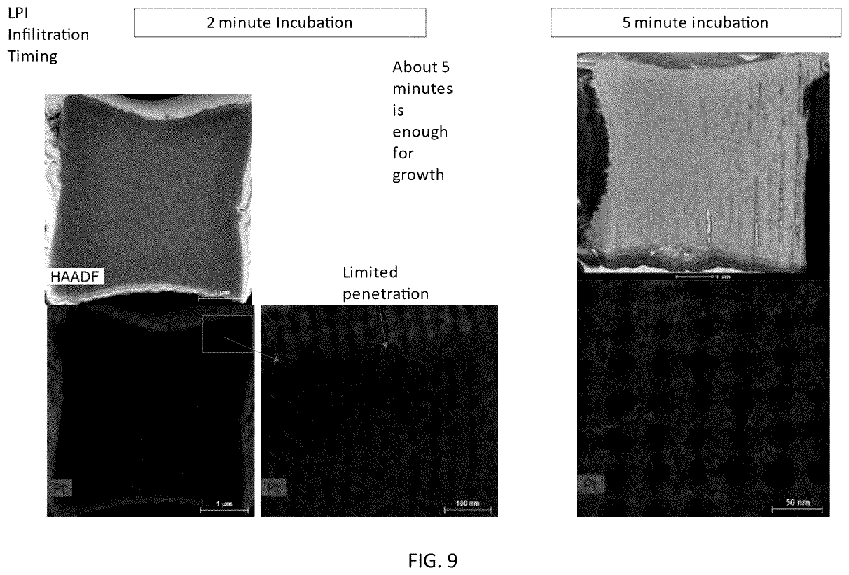

First, we investigated the use of LPI, where silicated DNA nanostructures situated on a Si substrate were exposed to a drop-cast solution of a metal salt of interest (dispersed in water or ethanol). Silica frameworks were incubated for 5 min to enable the sorption of metal ions to the silica superlattice, as shown in FIG. 2A. After removing the solution by spin-drying, the metal-incorporated nanostructures are then thermally annealed in a tube furnace in air at 250° C. for 5 min to remove water/ethanol. To arrive at optimal conditions for liquid-phase growth, metal salt concentration was held constant at 20 mM and incubation time was varied. Sodium tetrachloroplatinate was selected as the template platinum salt solution due to its long shelf life (˜4-6 months) to investigate templating parameters. We then applied EDS characterization for samples incubated with sodium tetrachloroplatinate for 1-20 min to study the templating process. EDS measurements showed that atomic percentage plateaued for incubation time above 10 minutes (see FIG. 8). Further investigation with transmission electron microscopy (TEM) demonstrated that nanostructures were self-limiting, and that further incubation did not result in the growth of a thicker coating. On the other hand, TEM cross-section of the 2-min vs 5-min incubation (See FIG. 9) demonstrated that 2 min did not allow for homogenous growth due to insufficient penetration into the lattice framework, whereas 5 min provided an even distribution of metal throughout. For all subsequent metal species demonstrated in this work, the precursor solution concentration (20 mM) and incubation time were kept constant at 5 min for comparison.

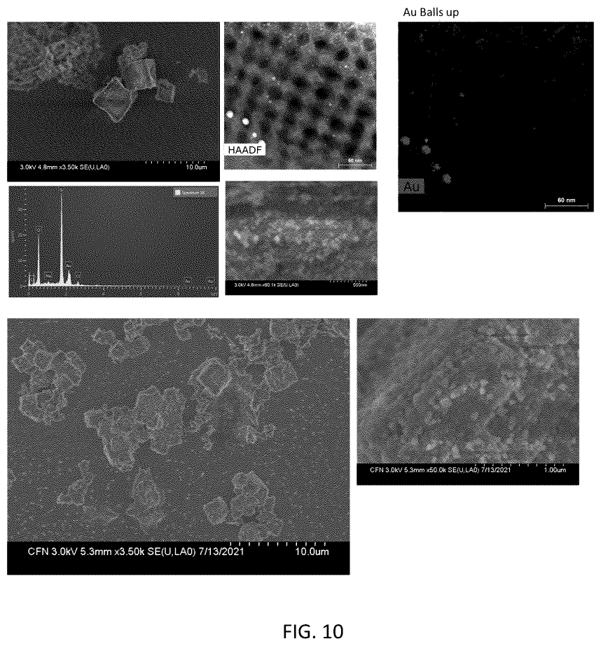

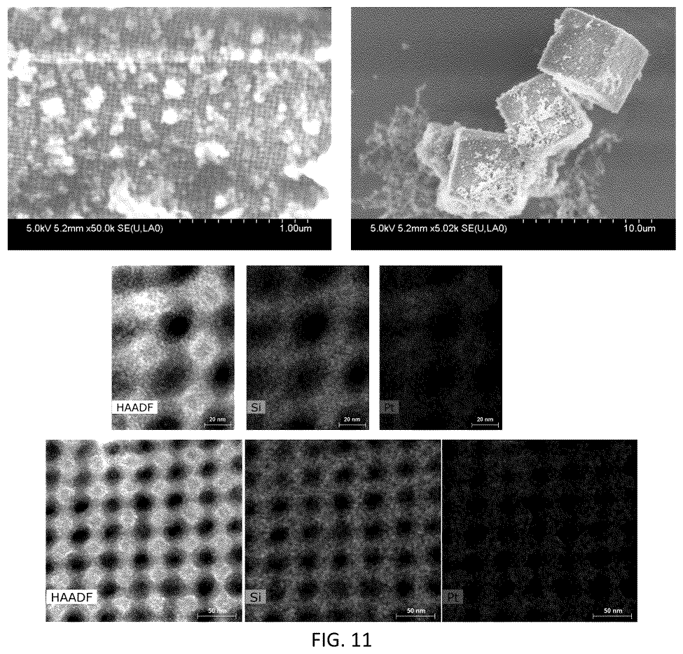

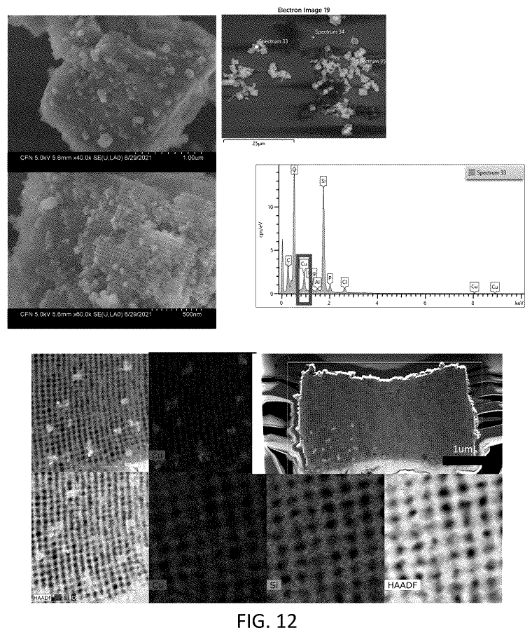

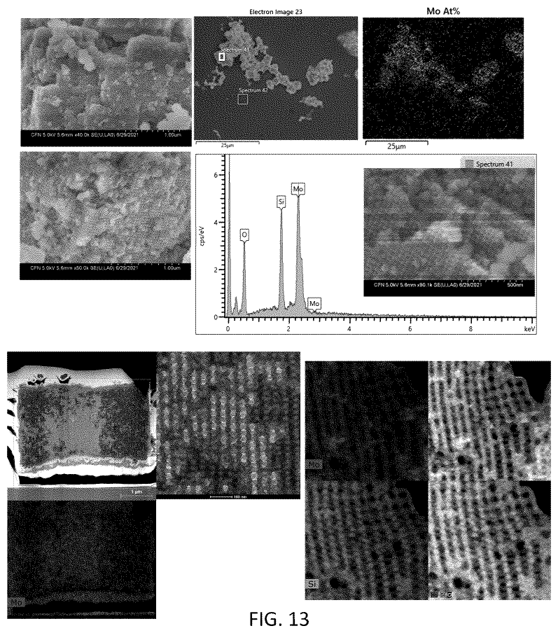

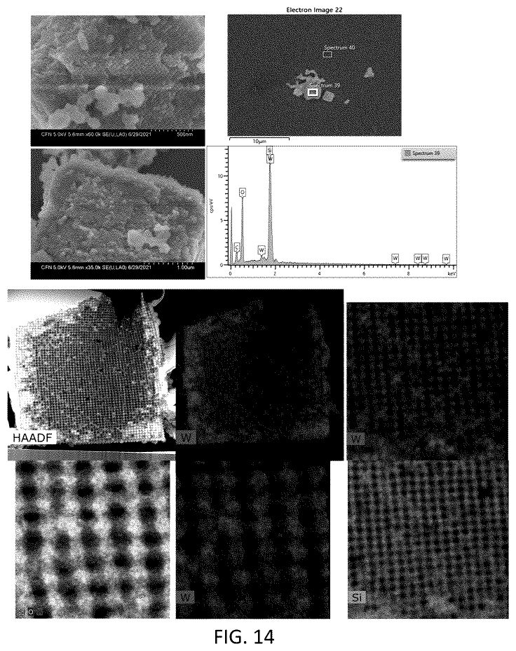

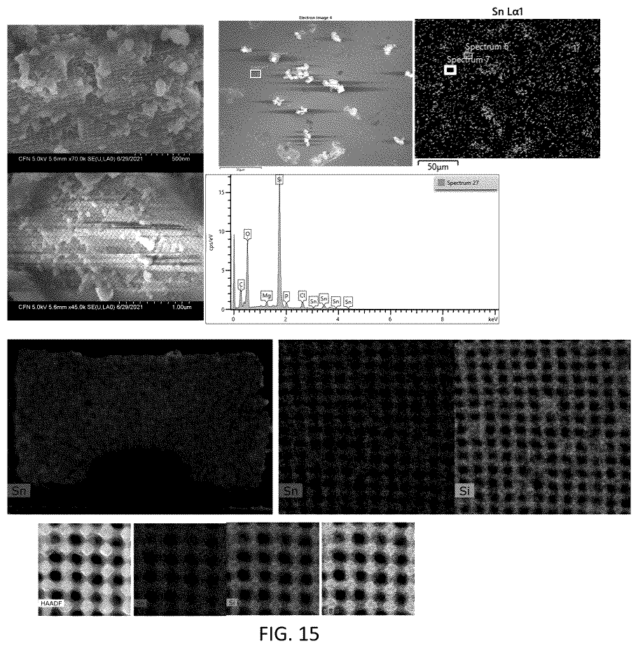

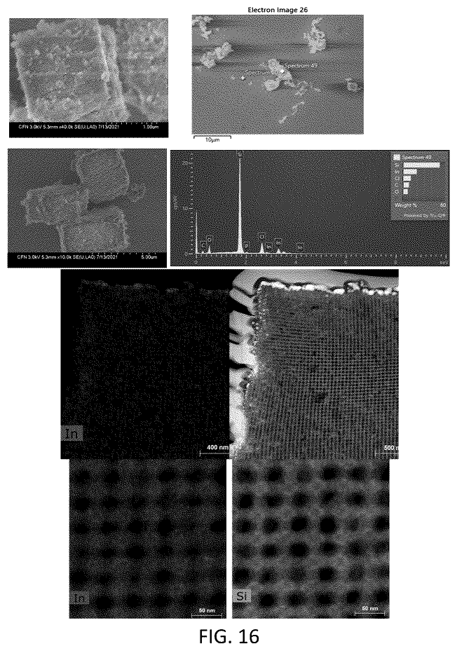

For incorporating a single-element species, both simple and complex chloride salts coordinated by ammonium or sodium were investigated, including indium chloride, ammonium tetrachlorocuprate dihydrate, ammonium molybdate tetrahydrate, ammonium tungstate, ammonium tin chloride, sodium tetrachloroaurate, and sodium tetrachloroplatinate. In FIG. 2B we show the TEM-obtained cross-sectional elemental mapping data based on EDS measurements of templated frameworks for various elements, including, copper, molybdenum, platinum, tungsten, indium, and tin. The formed inorganic frameworks consist of 4-5 nm thickness of these materials coated onto the surface of silica frameworks and with high spatial fidelity, as defined by 3D DNA-assembled scaffold (see FIGS. 10-16).

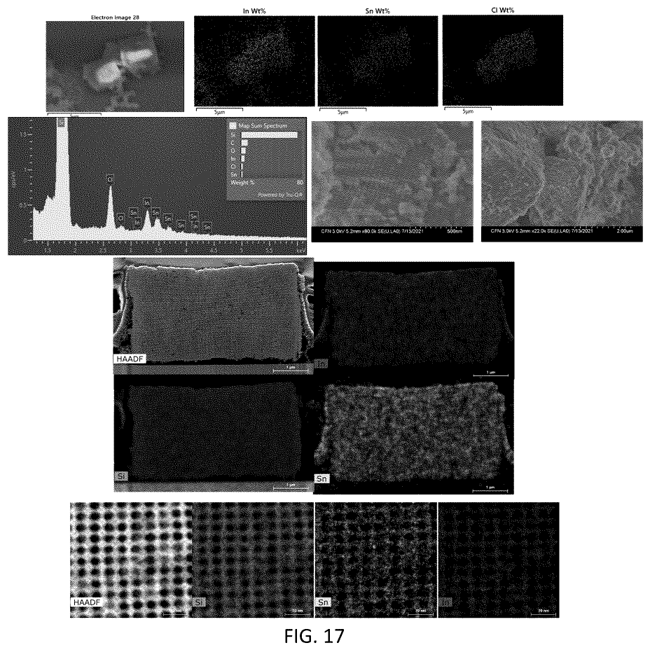

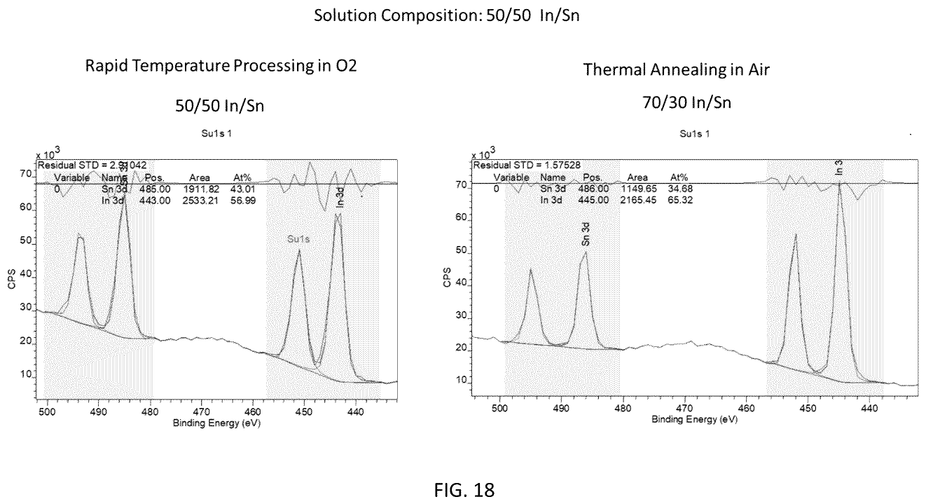

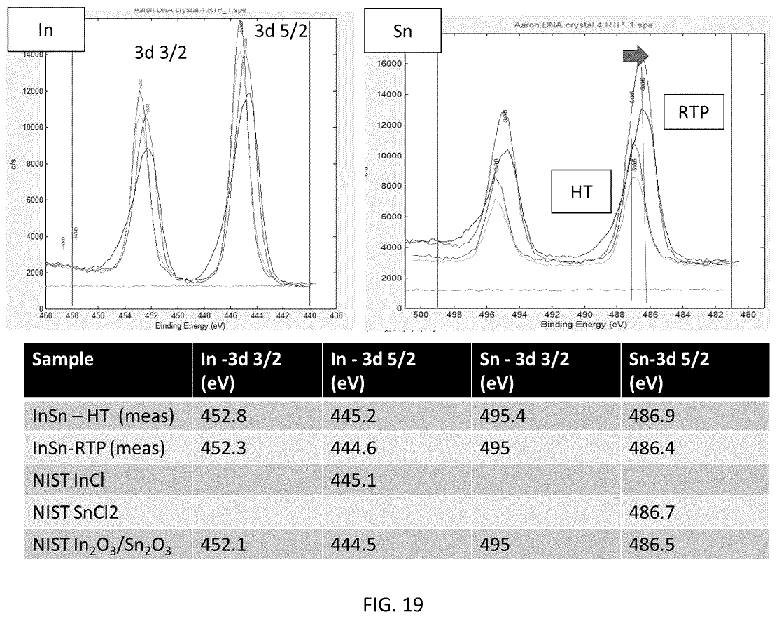

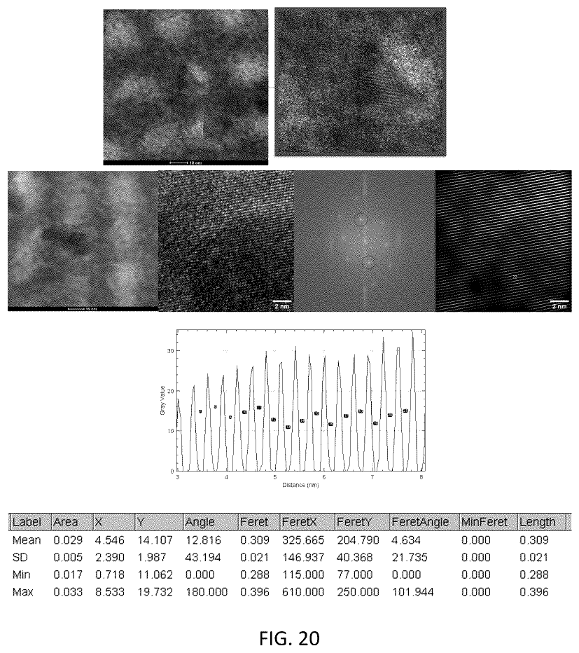

The simultaneous incorporation of multiple elements into a single nanocomposite framework lattice was further demonstrated by combining indium and tin for a multi-element superlattice composite. The cross-section TEM imaging (FIG. 2C, and FIG. 17) identifies nanocoated indium and tin along with chlorine, from the complex anion of the chloride-salt-based precursor solutions. Heat treatment at 300° C. in air with a 50/50 molar composition of indium and tin salt precursor oxidizes the metals to a limited extent but causes the removal of tin as measured by XPS (FIG. 18). Applying a rapid temperature processing (RTP) in oxygen at 600° C. for 5 min effectively preserves the intended metal composition and removes chlorine from the framework. This was confirmed by scanning electron microscopy (SEM) with EDS, FIG. 2D, applied on the infiltrated superlattice, which probes the elemental makeup of the sample volumetrically. The rapid thermal treatment oxidizes the structure to indium tin oxide (ITO), as shown in the X-ray photoemission spectroscopy (XPS) spectra collected before and after the RTP (FIG. 2E). The observed shifts of the indium and tin binding energies upon RTP compared with those in their respective tin and indium chloride states agree with what is expected from oxidation (see FIG. 19). X-ray diffraction data, performed on two motifs of indium tin oxide composites, 95%/5% and 50%/50%, In: Sn, FIG. 2F, along with XPS measurements support the formation of crystalline ITO on the silica superlattice framework. Further characterization by high-resolution TEM revealed crystalline domains of the order of 7 nm (FIG. 20).

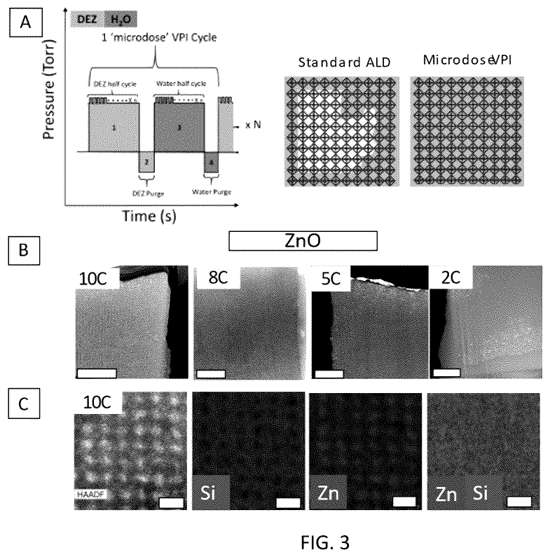

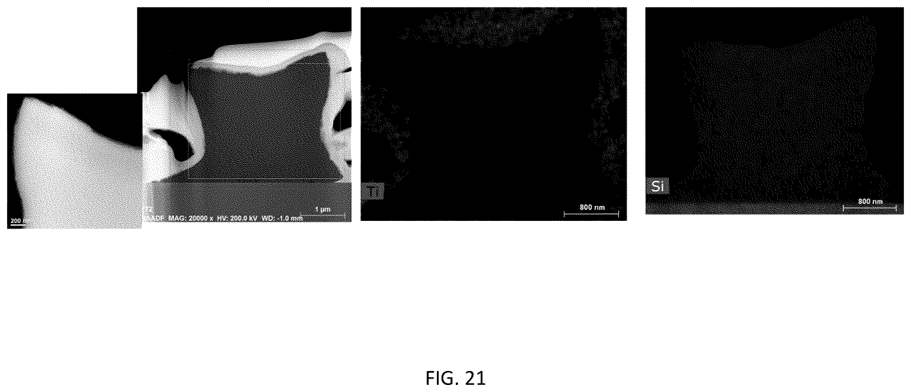

Next, we explored templating silica frameworks using VPI, derived from atomic layer deposition (ALD). The silica replicas of DNA lattices were exposed to vapor-phase organometallic precursors, such as TMA and diethylzinc (DEZ) for AlOₓ and ZnOₓ respectively, and water (oxidant) in a cyclic manner using a microdose precursor exposure protocol, as shown in FIG. 3A. During the normal ALD process, carrier gas such as N₂ or Ar flows continuously, and material precursors, such as TMA and H₂O for AlOₓ, are briefly pulsed (for tens of milliseconds) sequentially, with each pulse being separated by a short waiting period (a few seconds) to complete one ALD cycle. The constant purging and evacuation during normal ALD in principle ensure that unreacted precursors are removed from the surface and only monolayer deposition occurs per ALD cycle. However, for large 3D structures with small, sub-50 nm pores like the DNA-derived nanolattice, such a normal ALD protocol does not allow enough time for precursors to fully penetrate into the interior section of the 3D porous structure or for unreacted precursors to fully diffuse out of the interior, therefore leading to a clogged material deposition limited to sub-surface depth of a nanolattice, as schematically shown in FIGS. 3A and 21.

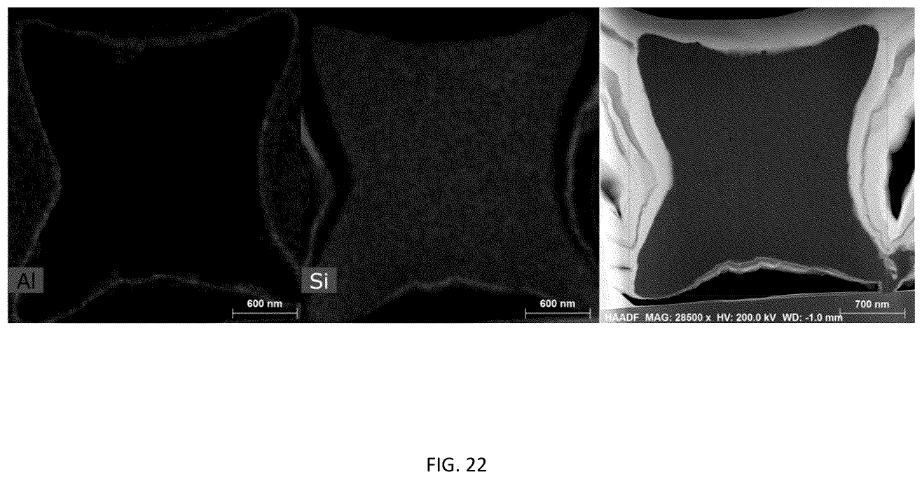

In contrast, during VPI process, the precursor pulsing cycles are initiated under a static vacuum (i.e., no carrier gas flow, with the reactor chamber being isolated from evacuation) followed by a long “exposure period” (up to tens of minutes or even hours) before re-evacuating and purging the chamber; this exposure period allows the precursors to fully diffuse (i.e., infiltrate) into a large, 3D porous nanostructure and get deposited within the pore interior surfaces. Specifically for this study, material precursors were exposed to the silica nanolattice under a static vacuum for 600 s followed by purging with flowing nitrogen and evacuation for the same duration. Again, the long exposure ensured enough time for the precursors to fully diffuse into the entire porous silicated DNA lattice and bind to reactive surface sites on the frame struts of the nanostructure. At the same time, the long purge removed most of the excess precursor physiosorbed and/or kinetically trapped within the pore, preventing uncontrolled spurious deposition and associated pore clogging. The infiltration approach thus preserved the nanostructure architecture. However, it is noted that given the large size of superlattice (˜microns) domains, some of these extra precursors still remain inside, contributing to the deposition of material amounts beyond the normal ALD limit during the VPI process. This effect becomes evident for a 3D structure with smaller nanopores—if silica growth resulted in pores less than 10 nm, nanolattices showed similar clogging to standard ALD, see FIG. 22. Thus, following VPI coating, we then probed the internal penetration of vapor-phase precursors and the resulting 3D inorganic templating into the silicate lattice framework using cross-sectional TEM analysis.

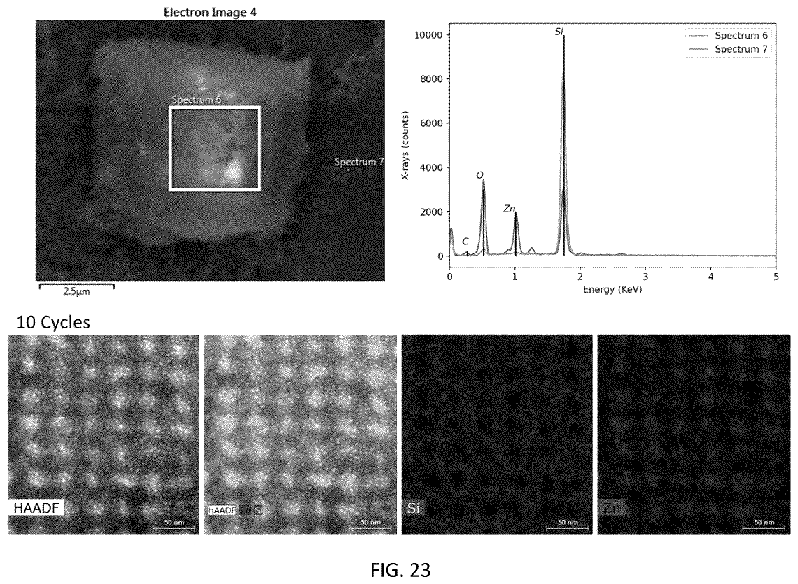

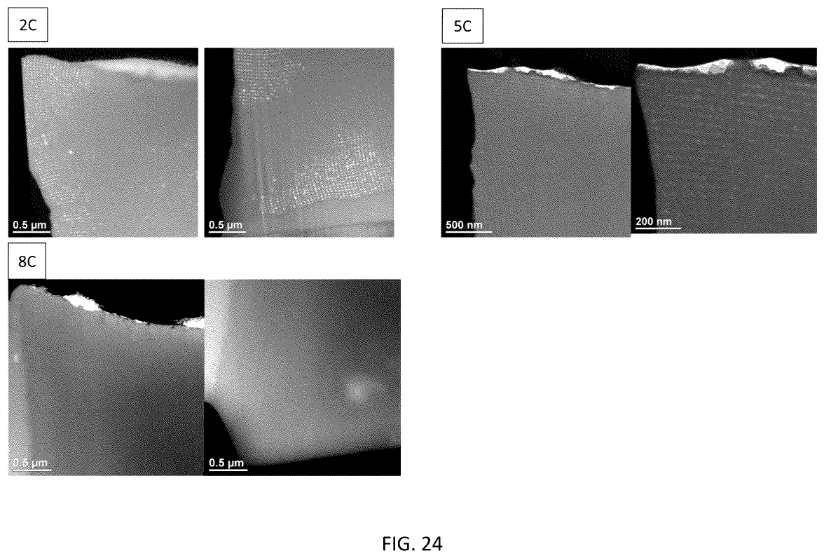

The cross-section of the ZnOₓ-infiltrated silicate superlattice, FIGS. 3B and 23, displayed a complete filling of the pores of the internal structure after 10 VPI cycles. Reducing the number of VPI cycles from 10 to 2 decreases the total amount of infiltrated ZnOₓ into the structure, while not substantially cutting down on over-growth (see FIG. 24 for additional cross-section imaging). HAADF imaging of the 10-cycle structure, FIG. 3C, shows the silica as a network lattice (black) with white areas representing ZnOₓ, as revealed by EDS elemental maps of the region.

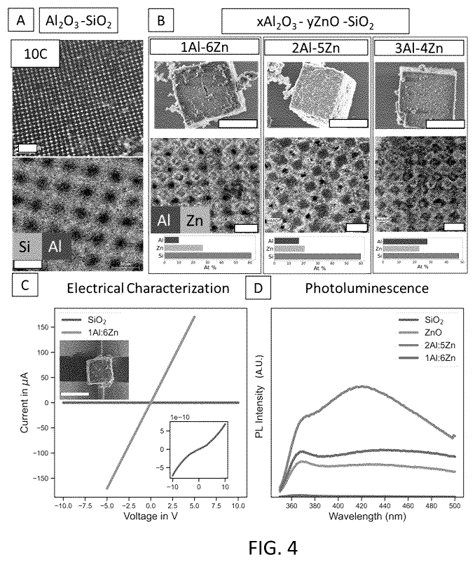

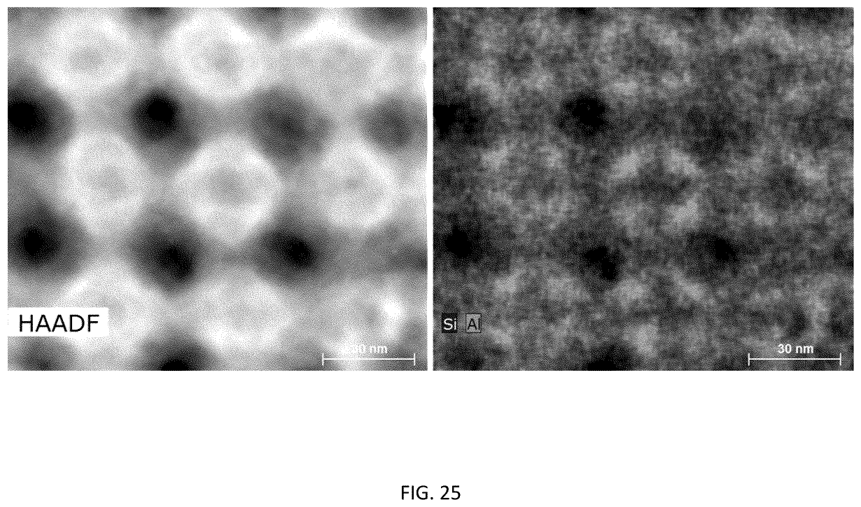

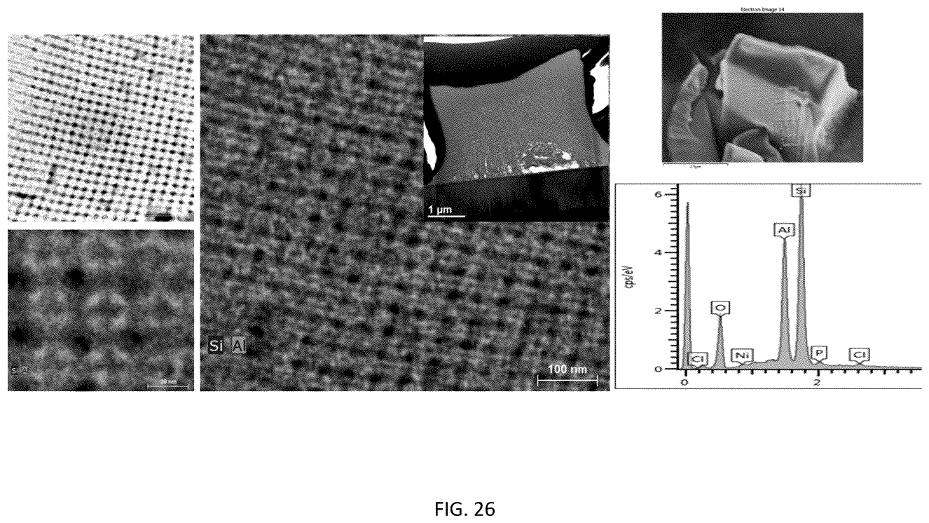

Applying 10-cycle AlOₓ VPI using TMA precursor resulted in a 5-7 nm growth of AlOₓ on the strut surface, leaving open pores in the framework rather than completely filling the pore as in the ZnOₓ case. The AlOₓ infiltration appeared uniform across the 5 mm wide superlattice sample, as shown in FIGS. 4A and 25, 26. The difference in the apparent growth rate between the TMA and DEZ growth on the silica superlattice is attributed to subtle differences in the organometallic precursor affinities for the —OH bonds on the surface of the silica framework.

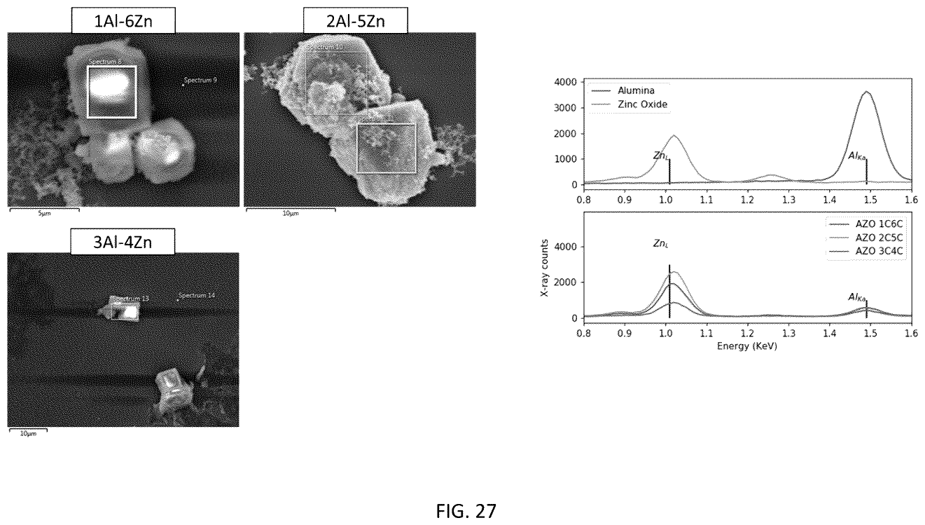

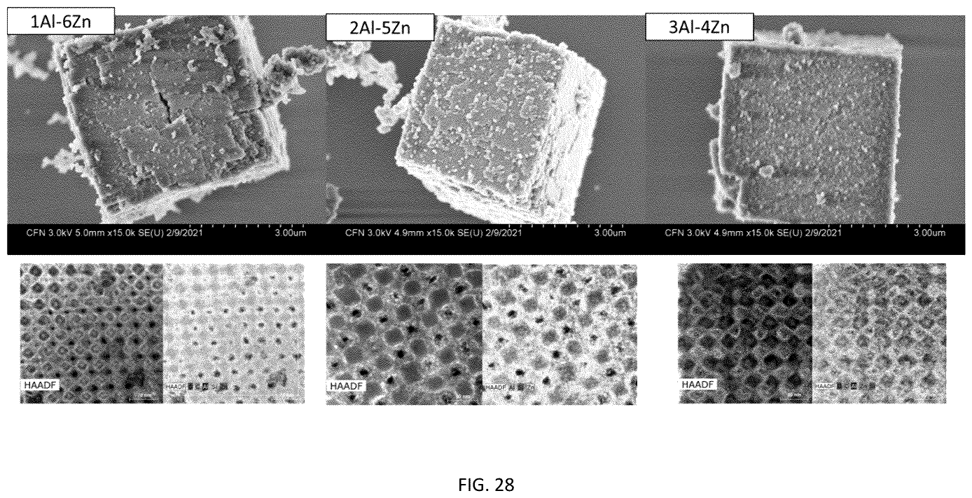

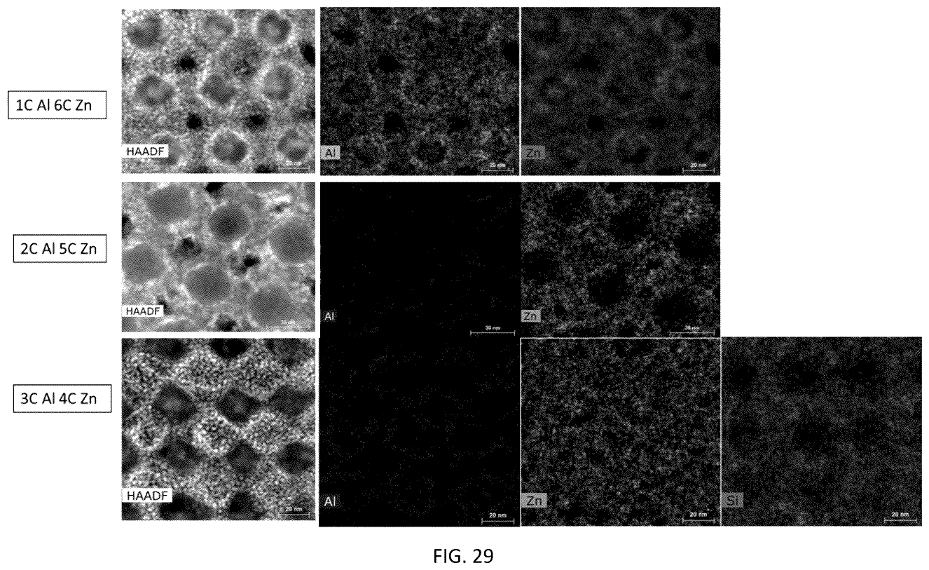

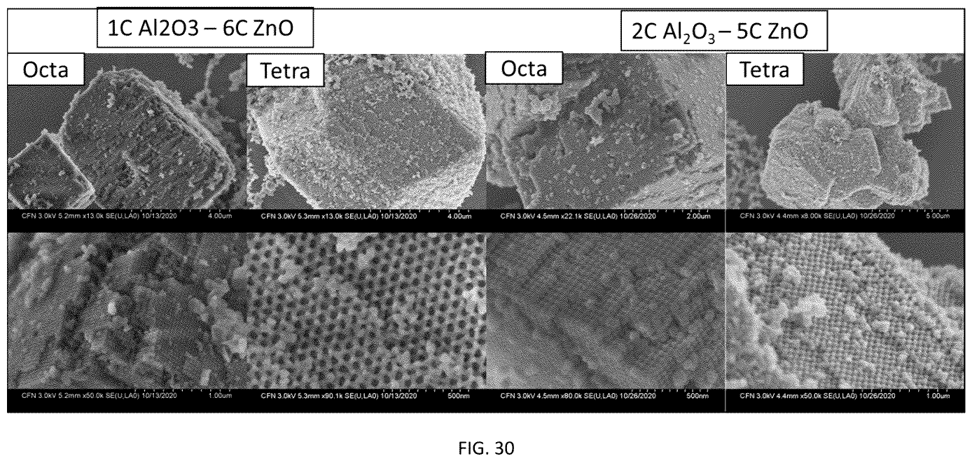

Leveraging the uniform coating of AlOₓ on the silica framework struts, a single cycle of AlOₓ VPI was used as an initial passivating step (AlOₓ-priming) before ZnOₓ VPI for the controlled growth of ZnOₓ layer. AlOₓ-priming and 6 ZnOₓ VPI cycles resulted in a uniform coating on the superlattice with pores extending throughout the structure. In FIG. 4B we show that we can tune the amount of Al vs Zn in the superlattice while retaining the nanostructure. As the number of AlOₓ priming cycles is increased relative to ZnOₓ VPI cycles, the relative amount of alumina increased as seen in accompanying HAADF-EDS maps of samples with increasing Al cycles. The EDS qualitatively showed that increasing TMA from 1 to 3 cycles increased the atomic percent from 10 to >30 at. % of the matrix makeup, while the signal for zinc stayed approximately the same comparing 4, 5, and 6 cycles, see FIG. 4B and FIGS. 27-30.

We further investigated the electrical conductivity and optoelectronic properties of the resulting aluminum doped ZnO (AZO) framework, as shown in FIG. 4C. Pt electrical contacts were patterned to connect to an isolated nanolattice. We observed four orders of magnitude increase in the measured current for AZO nanolattice compared to the nominal silica nanolattice.

The photoluminescence (PL) spectroscopy measurements, FIG. 4D, on the zinc oxide superlattice demonstrated characteristic near band edge emission in the UV region at approximately 375 nm and a broad emission from 380 to 500 nm. The broad emission is related to atomic impurities and defect emission and dopants from the underlying silica. This broad defect emission region is further enhanced upon the addition of aluminum priming to the VPI, analogous to enhancing the green emission of ZnO devices.

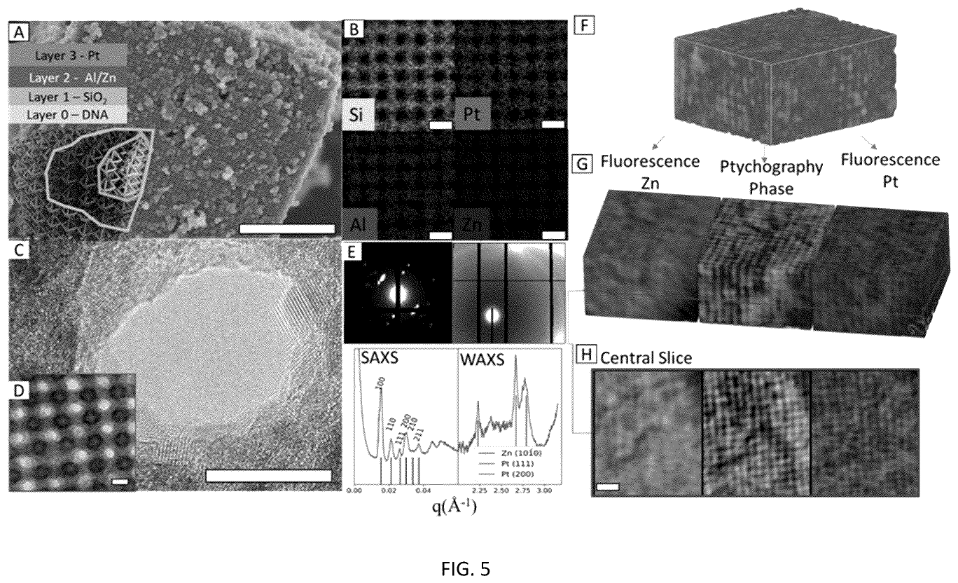

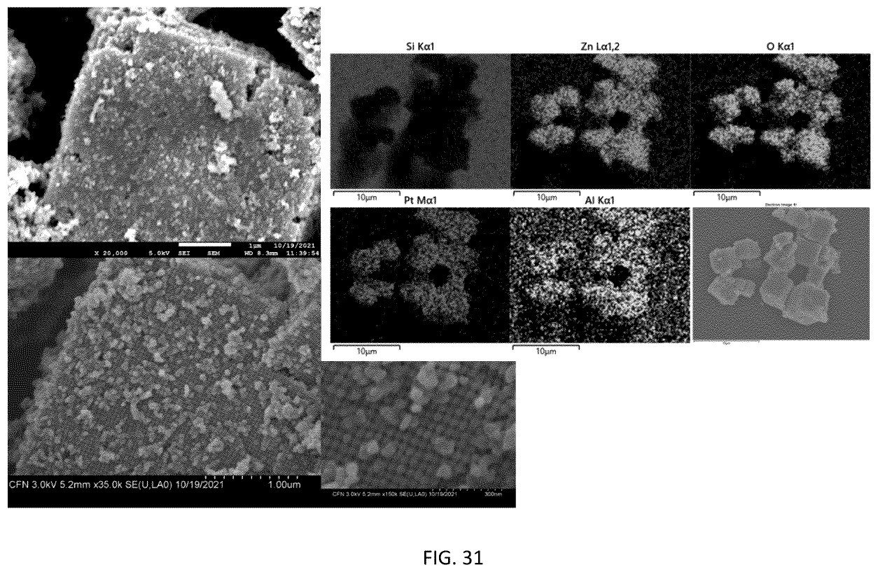

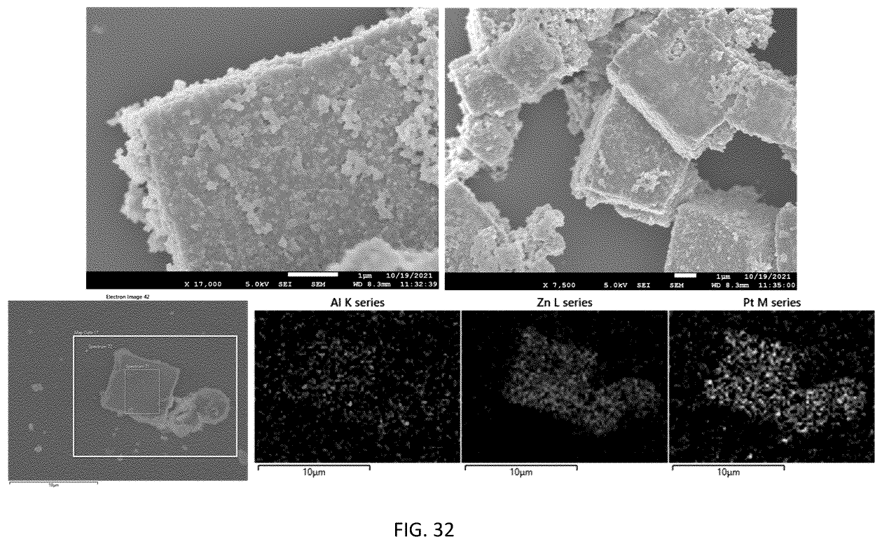

Having demonstrated the capability to coat the structure with multiple individual elements and their combinations, we further demonstrate combining LPI and VPI methods to broaden the possible material composition of frameworks. As a case example, we combined platinum LPI alongside aluminum primed zinc oxide VPI by successive processing and the resulting structures were characterized by cross-sectional electron microscopy. The optimal coating was found by performing VPI of alumina-primed zinc oxide followed by LPI of platinum, (see FIG. 31, additionally, see FIG. 32 for LPI followed by VPI). A schematic of the system is shown in FIG. 5A, whereby the DNA followed by silica coating is layered with alumina-primed zinc oxide and platinum, as imaged by SEM. A cross-sectional EDS maps (FIG. 5B) show uniform internal coatings of all three elements on the silica nanostructure. Further high-resolution TEM reveals crystalline domains within 5-10 nm coating (FIGS. 5C and inset 5D).

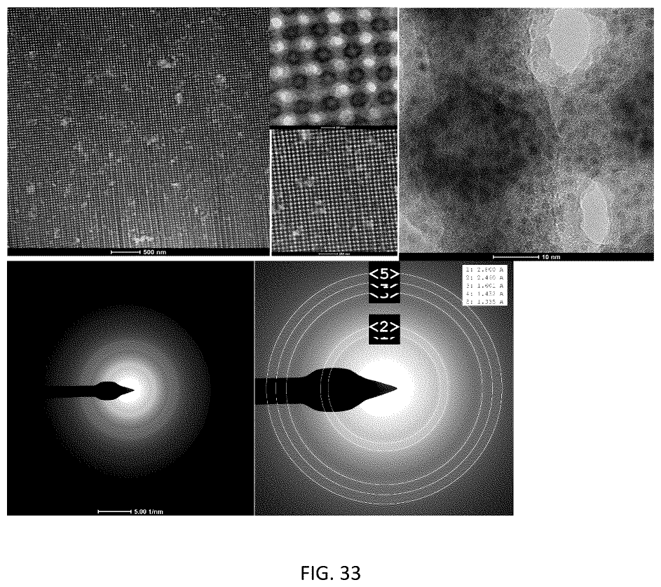

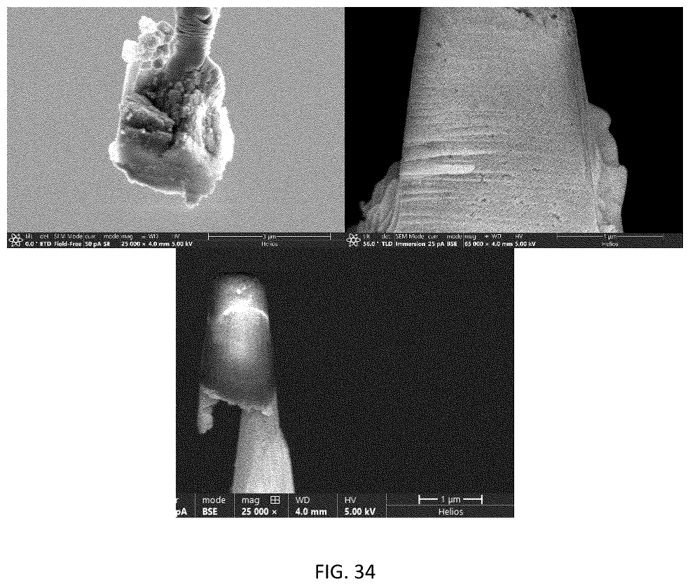

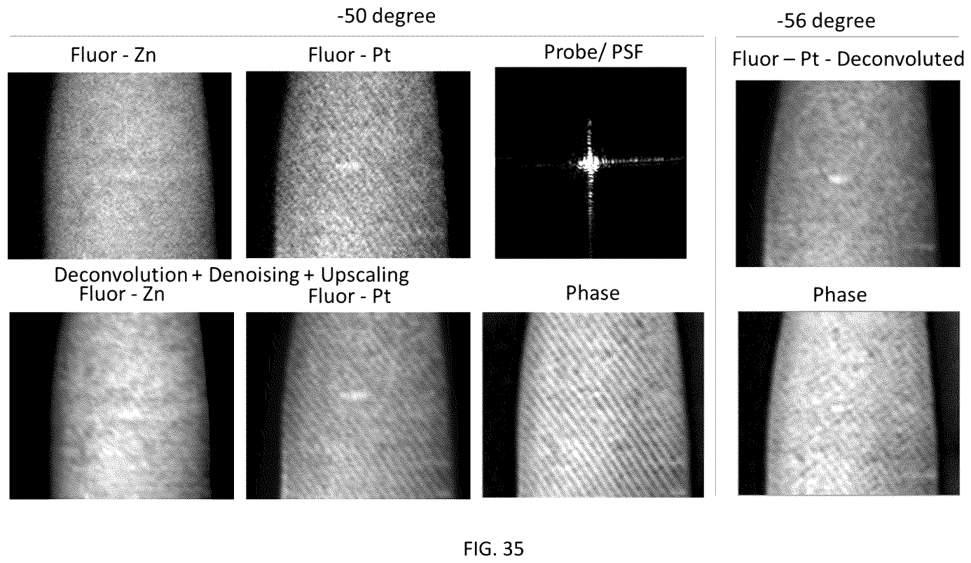

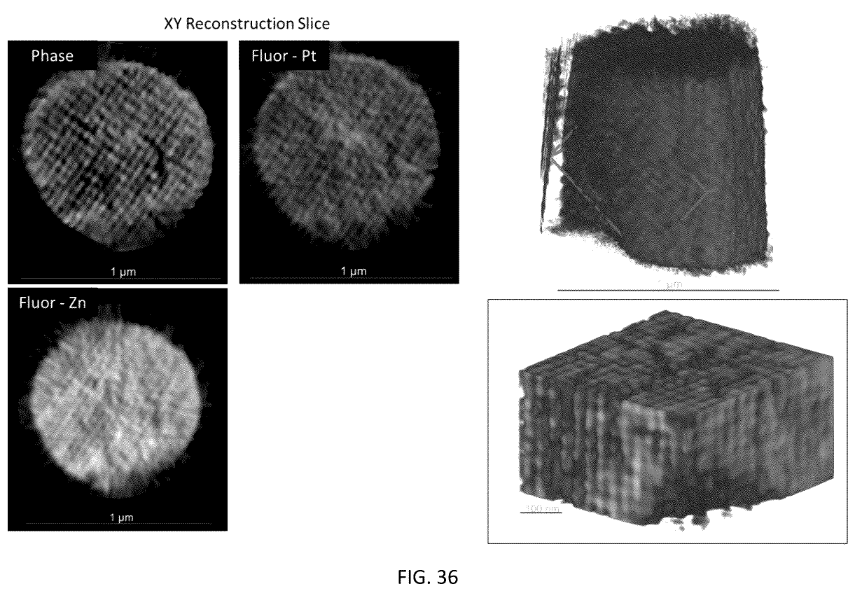

The global structure from selected area diffraction shows polycrystalline domains of ZnO and platinum throughout the Pt-AZO-silica framework structure, see FIG. 33. Simultaneous small-angle and wide-angle X-ray scattering (SAXS/WAXS) of the formed structure (FIG. 5E), reveals nanoscale and atomic structure of frameworks. Scattering captures their hierarchical organization with a SAXS peak at 0.0148 Å⁻¹ corresponding to the 42 nm spacing simple cubic nanolattice of DNA octahedra frames, while on atomic scale zinc oxide and platinum oxide are in hexagonal P6₃mc and in Fm3̅m space groups, respectively. To further probe the 3D structure volumetrically and determine if architecture and elemental composition are consistent throughout the entire Pt-AZO-silica framework domains, we performed scanning hard x-ray microscopy. By leveraging the fluorescence from platinum and zinc when excited by the 12 KeV photon beam, 3D tomographic data was collected at the hard x-ray nanoprobe beamline of National Synchrotron Light Source II. The x-ray phase image at each projection angle was retrieved from far-field diffraction patterns with ptychography algorithm, aligned and stacked with simultaneous fluorescence, see FIGS. 34-31. They are then used for tomographic reconstruction of formed frameworks. The reconstructed 3D framework volume depicts the correspondence between the spatial features of the phase image, which reflects the electron density variations, and both reconstructed platinum and zinc fluorescence maps, as shown in FIGS. 5F and 5G. The central slice through the volume, see FIG. 5H, furthermore corroborate the 3D templating of the platinum and zinc on silica framework, thus, demonstrating a successful formation of 3D Pt-AZO-silica frameworks.

In conclusion, here we have demonstrated that designed superlattices of DNA frames can be utilized as scaffolds for the fabrication of single-element and composite inorganic frameworks with prescribed 3D architecture. Given a large library of metal salts and ALD precursors suitable for deposition on silica, the liquid and vapor infiltration protocols allow for the fabrication of diverse inorganic nanostructures through templating DNA-prescribed nanolattice frameworks. We have established 3D templating approaches and investigated the chemical and structural states of these inorganic frameworks. The study demonstrates the development of LPI and VPI post-processing to fully oxidize infiltrated metals within frameworks. The electrical and optical properties of semiconductor frameworks were explored. Transferring a multitude of DNA-defined geometries to a large structural diversity of inorganic materials allows one to generate open framework 3D nanostructures with optical, mechanical, electrical and catalytic functions. Thus, the presented 3D nanofabrication strategy enables a broad range of application requiring 3D nanostructures with complex prescribed architectures and compositions.

### Materials & Methods

### DNA Origami Synthesis and Superlattice Assembly

DNA-origami octahedra were formed by mixing M13mp18 DNA scaffold and DNA staples strands with a 1:5 ratio in 1×TAE buffer (40 mM tris acetate, 1 mM EDTA) with 12.5 mM Mg²⁺ and slowly annealed over 20 hrs from 90° C. to room temperature over the course of 20 hrs for origami formation, overall a −0.2 C/hr ramp rate. Superlattices of DNA origami was formed by mixing two DNA-octahedron with complementary DNA bases at the vertices. The origami were mixed to form a 20 nM concentration solution at 20-50 ul. The sample was annealed in a PCR over 5 days from 50° C. to RT at −0.2 deg/hr. Robust DNA origami superlattices were made by growing a layer of Silica on the DNA bundle. For conversion to inorganic silica, superlattices were centrifuged and supernatant was replaced with 0.1×TAE with 10 mM Mg. Separately silication buffer was prepared by adding 2.5 ul of (3-Aminopropyl)-triethoxysilane (APTES) and 10 ul of Tetraethoxysilane (TEOS) in a 0.1×TAE with 10 mM Mg buffer for a total volume of 500 ul. The solution was vortexed at 700 rpm for 30 minutes, filtered with 0.22 μm Millex-GV PVDF filter to remove large particulates, and then 5 ul of superlattice and 10 ul of the filtered silication buffer are mixed together. The solution was vortexed at 700 rpm for 1-2 hours and then centrifuged and the buffer exchanged with water.

### Structural and Elemental Characterization

Superlattices were characterized using SEM (Hitachi S-4800), Analytical SEM (Jeol 7600F SEM-EDS), and scanning TEM (FEI Talos F200X; 200 kV; equipped with the EDS elemental mapping capability). The cross-sectional TEM samples were prepared by the standard in-situ lift-out procedure using Ga ion milling in a focused ion beam system (FEI Helios 600 Nanolab). XRD was performed on a Rigaku Smartlab operating in 1D Grazing incidence using a zero diffraction silicon substrate. XPS was collected on a PHI Versaprobe II at CUNY ASRC.

### Scanning Hard X-Ray Tomography

The experiment was conducted at the Hard X-ray nanoprobe (HXN 3-ID) beamline of National Synchrotron Light Source II, Brookhaven National Laboratory. Superlattices coated in Platinum-Alumina primed Zinc oxide—Silica Superlattice were prepared with in-situ lift-out procedure using Ga ion milling to fashion a ˜1 um domain on a tungsten pin.

A monochromatic beam at 12 KeV was selected and focused by multilayer Laue lenses to a nanobeam approximately 13 nm. Flyscans were carried out in a grid of 120×100 with a step size of 10 nm with a 30 ms dwell time. In total 135 projections were used for reconstruction representing angles from −90 to +44. Far field diffraction was collected downstream while fluorescence was collected from an energy dispersive detector placed 90° from the beam to collect x-rays. Elements were fitted by PyXRF software package, separately ptychography was performed on the far field diffraction and recover the complex value probe and object function. The probe was subsequently used with state-of-the-art deconvolution techniques to further refine the simultaneously collected fluorescence.

### Small Angle X-Ray Scattering/Wide Angle X-Ray Scattering

Scattering experiments were performed at the Small Matter Interfaces (SMI, 12-ID) beamlines of the National Synchrotron Light source II, Brookhaven National Laboratory. A 16.1 KeV beam was micro-focused beam (2×25 μm) using CRL transfocator and was brought to the sample in transmission with a SAXS detector, Pilatus 1M, 8.3 meters away and simultaneous WAXS detector Pilatus 900KW 0.275 m from the sample. SAXS and WAXS results were reduced to 1D and fitted with GitHub—CFN-softbio/SciAnalysis: SciAnalysis is a set of Python scripts for batch processing of image data, including x-ray scattering detector images. and GitHub—CFN-softbio/ScatterSim: Meso scale SAXS Powder Simulations

Normal ALD Coating of TiOₓ and AlOₓ on DNA Lattices

The DNA Lattices were coated with TiOₓ and AlOₓ thin film using Cambridge Nanotech Savannah S100 ALD system (base pressure˜0.35 Torr) at 85° C. During each TiOₓ ALD cycle, titanium (IV) isopropoxide and water vapor were alternatively pulsed each for 0.4 s with 5-s interval under continuous N₂ flow. Each AlOₓ ALD includes 15 ms pulsation of Trimethyl Aluminum (TMA) and water vapor pulsing, separated by 10s N₂ purging. In total, 50 cycles were used to deposit TiOₓ and 10 cycles for AlOₓ.

### Vapor-Phase Infiltration (VPI)

The infiltration of ZnO, Sn, and AlOₓ on the silicate superlattices was carried out in a commercial ALD system (Cambridge Nanotech, Savannah S100) at 85° C. using DEZ and TMA as respective metal organic precursors along with water as an oxidant. A single ZnO infiltration cycle by the microdose protocol consists of, in sequence: exposure to DEZ for 600 s under a static vacuum (˜1.7 Torr); chamber purging using N₂ (100 sccm) for 600 s; exposure to water vapor for 600 s; and chamber purging using N₂ (100 sccm) for 600 s. A single AlOₓ infiltration cycle by the microdose protocol consists of the identical steps described above (chamber pressure of ˜1000 Torr during TMA infiltration). During the microdose precursor exposure period of 600 s, the precursors (both DEZ/TMA and water) dosing was repeated every 60 s during the exposure period (total 10 repeated dosings). The infiltration was followed by the initial removal of the organic polymer matrix by oxygen plasma ashing (20 W; 100 mTorr; 5 min; room temperature) and the further consolidation of the inorganic matrix and the removal of carbon impurities by O₂ rapid thermal process (RTP) treatment at 600° C. for 5 min (Modular Process Technology, RTP-600S).

### Liquid-Phase Infiltration (LPI)

Infiltration of metal salts diluted in either Ethanol or Di water were spin-coated onto superlattices dispersed on a silicon substrate. Nominally 20 ul of a 20 mM metal salt solution was deposited on the sample for 5 min followed by spin drying at 3000 RPM for 30 seconds. This was either followed by RTP or 5 min in a tube furnace in the air set to 250° C.

### Electrical Testing:

The two-probe I-V characteristics of devices were measured using an electrical probe station (Signatone) equipped with a dark box and a high-precision semiconductor parameter analyzer (Agilent). For the illuminated I-V characteristics, the devices were soaked for 2 min under the microscope's tungsten light before initiating measurements.

### Chemicals

Metal salts were purchased from Sigma Aldrich and Alfa Aesar. All chemicals were diluted to 20 mM in either water or ethanol. Approximately 20 ul were dropped onto the surface of silicon substrate with silica coated DNA superlattice spread on the surface for 5 minutes. The samples were then spun at 3000 rpm for 30 seconds followed by thermal annealing in air at 250° C. or RTP at 600° C. in oxygen. For combinations, equal volumes were mixed and drop cast onto the superlattices. The following exemplary, non-limiting chemicals were used:
Platinum (Na₂PtCl₄)—Water
Gold (NaAuCl₄)—Water/EtOH
Tin—NH₄SnCl₆—EtOH
Copper—NH₄CuCl₄—EtOH
Molybdenum—(NH₄)₆Mo₇O₂₄—Water
Tungsten—(NH₄)₆H₂W₁₂O₄₀—Water
Indium—InCl₃—EtOH

### ASPECTS

The following Aspects are illustrative only and do not limit the scope of the present disclosure or the appended claims. Any part or parts of any one or more Aspects can be combined with any part or parts of any one or more other Aspects.

Aspect 1. A composite, comprising: a three-dimensional (3D) silicate lattice, the silicate lattice comprising a first porous motif, the first porous motif optionally being characterized as polyhedral, the first porous motif optionally defining a pore size of from about 5 to about 100 nm; and a first inorganic layer superposed over the silicate lattice, the first inorganic layer optionally coupled to the silicate lattice.

The first porous motif can be polyhedral, as described. As but some non-limiting examples, the first porous motif can be tetrahedral, pentahedral, hexahedral, heptahedral, octahedral, nonahedral, or dodecahedral in configuration. The first porous motif can define a periodic structure, which structure can be periodic in two or more dimensions.

As explained elsewhere herein, the disclosed composites can have feature sizes—such as pores and/or side lengths—in the range of tens of nanometers, for example from about 10 nm to about 500 nm, from about 10 nm to about 200 nm, from about 10 nm to about 100 nm, or even from about 10 nm to about 50 nm.

Aspect 2. The composite of Aspect 1, wherein the first porous motif is characterized as tetrahedral.

Aspect 3. The composite of Aspect 1, wherein the first porous motif is characterized as octahedral.

Aspect 4. The composite of any one of Aspects 1-3, wherein the silicate lattice comprises a second porous motif. In this way, the silicate lattice can include a region having a first porous structure, and a region having a second porous structure, which second porous structure can differ from the first porous structure. Without being bound to any particular theory or embodiment, one can thus arrange the silicate lattice such that different parts of the lattice—and hence the composite—exhibit different characteristics. As but one example, one can thus form a composite that exhibits one optical characteristic at one location along the composite where the first porous motif is present and a second optical characteristic at another location along the composite where the second porous motif is present.

The second porous motif can define a periodic structure. The first porous motif and the second porous motif can be arranged in such a way that the silicate lattice comprises a region of the first porous motif that abuts a region of the second porous motif. The silicate lattice can be arranged such that portions of the first porous motif alternate with portions of the second porous motif, in the manner of an alternating copolymer.

Aspect 5. The composite of Aspect 4, wherein the second porous motif is characterized as polyhedral.

Aspect 6. The composite of any one of Aspects 4-5, wherein the second porous motif defines at least one of (1) a pore size that differs from the pore size of the first porous motif and (2) a 3D structure that differs from the 3D structure of the first porous motif.

As but one example, the average pore size of the first porous motif can differ from the average pore size of the second porous motif. For example, the average pore size of the first porous motif can differ from the average pore size of the second porous motif by, for example, from about 1 to about 500%, for example from about 1 to about 500%, from about 5 to about 400%, from 10 to about 300%, from about 25 to about 200%, or from about 50 to about 100%. The first porous motif can define a polyhedral that differs from a polyhedral defined by the second porous motif. As an example, the first porous motif can define a polyhedral that differs in its number of sides from the number of sides of the polyhedral of the second porous motif.

Aspect 7. The composite of any one of Aspects 1-6, wherein the first inorganic layer comprises any one or more of a metal and a metal oxide. A metal oxide can be doped, for example, with a metal.

Aspect 8. The composite of Aspect 7, wherein the metal comprises any one or more of aluminum, copper, gold, indium, molybdenum, platinum, tin, tungsten, or zinc.

Aspect 9. The composite of Aspect 7, wherein the metal oxide comprises any one or more of AlOx or ZnOx.

Aspect 10. The composite of any one of Aspects 1-9, further comprising a nucleic acid frame on which the silicate lattice is superposed.

Aspect 11. The composite of any one of Aspects 1-10, further comprising a second inorganic layer, the second inorganic layer being superposed over the first inorganic layer.

In some embodiments, a first portion of the composite presents a first metal or a first metal oxide to the environment and a second portion of the composite presents a second metal or a second metal oxide to the environment. This can be accomplished by, for example, coating the first portion with the first metal or the first metal oxide and coating the second portion with the second metal or the second metal oxide. In some instances, this can be accomplished by coating the silicate lattice with the first metal or the first metal oxide and the coating a selected portion of the silicate lattice with the second metal or the second metal oxide.

Aspect 12. A device, the device comprising the composite according to any one of Aspects 1-11. Such a device can be useful as, for example, a framework 3D structure with any one or more of optical, mechanical, electrical and catalytic functions. Applications for the disclosed technology include, without limitation, advanced nanolithography, neuromorphic computing, energy materials, metamaterials, optics, materials with hybrid properties, water filtration, and drug delivery.

Aspect 13. A method, comprising: forming a silicate layer superposed on a 3D nucleic acid lattice, the 3D nucleic acid lattice comprising a first porous motif, the first porous motif optionally being characterized as polyhedral, the first porous motif optionally defining a pore size of from about 5 to about 100 nm; and forming a first inorganic layer superposed over the silicate layer, the first inorganic layer optionally coupled to the silicate layer.

Aspect 14. The method of Aspect 13, wherein the first porous motif is characterized as tetrahedral or octahedral.

Aspect 15. The method of any one of Aspects 13-14, wherein the 3D nucleic acid lattice comprises a second porous motif, wherein the second porous motif defines at least one of (1) a pore size that differs from the pore size of the first porous motif and (2) a 3D structure that differs from the 3D structure of the first porous motif.

Aspect 16. The method of any one of Aspects 13-15, wherein forming the first inorganic layer comprises any one or more of a vapor phase infiltration or a liquid phase infiltration.

Aspect 17. The method of any one of Aspects 13-16, wherein the first inorganic layer comprises any one or more of a metal or a metal oxide.

Aspect 18. The method of Aspect 17, wherein the metal comprises any one or more of Al, Au, Cu, In, Mo Pt, Sn, W, and Zn.

Aspect 19. The method of Aspect 17, wherein the metal oxide comprises any one or more of AlOx and ZnOx.

Aspect 20. The method of any one of Aspects 13-19, further comprising forming a second inorganic layer superposed over the first inorganic layer.

### REFERENCES

1. J. A. Liddle, G. M. Gallatin, Nanomanufacturing: A Perspective. ACS Nano 10, 2995-3014 (2016).
2. T. Tanaka, A. Ishikawa, Towards three-dimensional optical metamaterials. Nano Convergence 4, 34 (2017).
3. A. Michelson, T. J. Flanagan, S.-W. Lee, O. Gang, High-strength, lightweight nano-architected silica. Cell Reports Physical Science 4, 101475 (2023).
4. L. Gloag, A. R. Poerwoprajitno, S. Cheong, Z. R. Ramadhan, T. Adschiri, J. J. Gooding, R. D. Tilley, Synthesis of hierarchical metal nanostructures with high electrocatalytic surface areas. Science Advances 9, eadf6075 (2023).
5. M. A. Saccone, R. A. Gallivan, K. Narita, D. W. Yee, J. R. Greer, Additive manufacturing of micro-architected metals via hydrogel infusion. Nature 612, 685-690 (2022).
6. J. Li, J. Yan, L. Jiang, J. Yu, H. Guo, L. Qu, Nanoscale multi-beam lithography of photonic crystals with ultrafast laser. Light: Science & Applications 12, 164 (2023).
7. Y. Liang, M. Frederik, H. F. B. Uwe, B. Eva, W. Martin, Multimaterial multi-photon 3D laser micro- and nanoprinting. Light: Advanced Manufacturing 2, 296-312 (2021).
8. Z. C. Ma, Y. L. Zhang, B. Han, Q. D. Chen, H. B. Sun, Femtosecond-Laser Direct Writing of Metallic Micro/Nanostructures: From Fabrication Strategies to Future Applications. Small Methods 2, 1700413 (2018).
9. K. W. Tan, U. Wiesner, Block Copolymer Self-Assembly Directed Hierarchically Structured Materials from Nonequilibrium Transient Laser Heating. Macromolecules 52, 395-409 (2019).
10. A. Klinkova, R. M. Choueiri, E. Kumacheva, Self-assembled plasmonic nanostructures. Chemical Society Reviews 43, 3976-3991 (2014).
11. C. Yuan, W. Ji, R. Xing, J. Li, E. Gazit, X. Yan, Hierarchically oriented organization in supramolecular peptide crystals. Nature Reviews Chemistry 3, 567-588 (2019).
12. M. A. Boles, M. Engel, D. V. Talapin, Self-Assembly of Colloidal Nanocrystals: From Intricate Structures to Functional Materials. Chemical Reviews 116, 11220-11289 (2016).
13. Y. Li, W. Zhou, I. Tanriover, W. Hadibrata, B. E. Partridge, H. Lin, X. Hu, B. Lee, J. Liu, V. P. Dravid, K. Aydin, C. A. Mirkin, Open-channel metal particle superlattices. Nature 611, 695-701 (2022).
14. S.-H. Yu, R. O'Reilly, L. Jiang, N. A. Kotov, The New Era of Self-Assembled Nanomaterials. Accounts of Chemical Research 55, 1783-1784 (2022).
15. J. S. Kahn, O. Gang, Designer Nanomaterials through Programmable Assembly. Angewandte Chemie International Edition 61, e202105678 (2022).
16. F. Hong, F. Zhang, Y. Liu, H. Yan, DNA Origami: Scaffolds for Creating Higher Order Structures. Chemical Reviews 117, 12584-12640 (2017).
17. T. Zhang, C. Hartl, K. Frank, A. Heuer-Jungemann, S. Fischer, P. C. Nickels, B. Nickel, T. Liedl, 3D DNA origami crystals. Advanced Materials 30, 1800273 (2018).
18. P. W. Rothemund, Folding DNA to create nanoscale shapes and patterns. Nature 440, 297-302 (2006).
19. S. M. Douglas, H. Dietz, T. Liedl, B. Högberg, F. Graf, W. M. Shih, Self-assembly of DNA into nanoscale three-dimensional shapes. Nature 459, 414-418 (2009).
20. L. Shani, P. Tinnefeld, Y. Fleger, A. Sharoni, B. Y. Shapiro, A. Shaulov, O. Gang, Y. Yeshurun, DNA origami based superconducting nanowires. AIP Advances 11, 015130 (2021).
21. Y. Geng, J. Liu, E. Pound, S. Gyawali, J. N. Harb, A. T. Woolley, Rapid metallization of lambda DNA and DNA origami using a Pd seeding method. Journal of Materials Chemistry 21, 12126-12131 (2011).
22. A. C. Pearson, J. Liu, E. Pound, B. Uprety, A. T. Woolley, R. C. Davis, J. N. Harb, DNA origami metallized site specifically to form electrically conductive nanowires. The Journal of Physical Chemistry B 116, 10551-10560 (2012).
23. R. Wang, G. Zhang, H. Liu, DNA-templated nanofabrication. Current Opinion in Colloid & Interface Science 38, 88-99 (2018).
24. P. W. Majewski, A. Michelson, M. A. L. Cordeiro, C. Tian, C. Ma, K. Kisslinger, Y. Tian, W. Liu, E. A. Stach, K. G. Yager, O. Gang, Resilient three-dimensional ordered architectures assembled from nanoparticles by DNA. Science Advances 7, eabf0617 (2021).
25. Y. Shang, N. Li, S. Liu, L. Wang, Z. G. Wang, Z. Zhang, B. Ding, Site-Specific Synthesis of Silica Nanostructures on DNA Origami Templates. Adv Mater, e2000294 (2020).
26. X. Liu, F. Zhang, X. Jing, M. Pan, P. Liu, W. Li, B. Zhu, J. Li, H. Chen, L. Wang, Complex silica composite nanomaterials templated with DNA origami. Nature 559, 593-598 (2018).
27. L. Nguyen, M. Döblinger, T. Liedl, A. Heuer-Jungemann, DNA-origami-templated silica growth by sol-gel chemistry. Angewandte Chemie International Edition 58, 912-916 (2019).
28. M.-K. Nguyen, V. H. Nguyen, A. K. Natarajan, Y. Huang, J. Ryssy, B. Shen, A. Kuzyk, Ultrathin silica coating of DNA origami nanostructures. Chemistry of Materials 32, 6657-6665 (2020).
29. S. Wu, M. Zhang, J. Song, S. Weber, X. Liu, C. Fan, Y. Wu, Fine customization of calcium phosphate nanostructures with site-specific modification by DNA templated mineralization. ACS nano 15, 1555-1565 (2020).
30. A. Michelson, H. Zhang, S. Xiang, O. Gang, Engineered Silicon Carbide Three-Dimensional Frameworks through DNA-Prescribed Assembly. Nano Letters 21, 1863-1870 (2021).
31. L. Shani, A. N. Michelson, B. Minevich, Y. Fleger, M. Stern, A. Shaulov, Y. Yeshurun, O. Gang, DNA-assembled superconducting 3D nanoscale architectures. Nature communications 11, 1-7 (2020).
32. S. Barany, V. Strelko, Laws and mechanism of adsorption of cations by different ion-exchange forms of silica gel. Adsorption 19, 769-776 (2013).
33. H. I. Akyildiz, M. Lo, E. Dillon, A. T. Roberts, H. O. Everitt, J. S. Jur, Formation of novel photoluminescent hybrid materials by sequential vapor infiltration into polyethylene terephthalate fibers. Journal of Materials Research 29, 2817-2826 (2014).
34. A. Rahman, P. W. Majewski, G. Doerk, C. T. Black, K. G. Yager, Non-native three-dimensional block copolymer morphologies. Nature Communications 7, 13988 (2016).
35. A. Subramanian, G. Doerk, K. Kisslinger, D. H. Yi, R. B. Grubbs, C.-Y. Nam, Three-dimensional electroactive ZnO nanomesh directly derived from hierarchically self-assembled block copolymer thin films. Nanoscale 11, 9533-9546 (2019).
36. A. Subramanian, N. Tiwale, G. Doerk, K. Kisslinger, C.-Y. Nam, Enhanced Hybridization and Nanopatterning via Heated Liquid-Phase Infiltration into Self-Assembled Block Copolymer Thin Films. ACS Applied Materials & Interfaces 12, 1444-1453 (2020).
37. A. Subramanian, N. Tiwale, W.-I. Lee, C.-Y. Nam, Templating Functional Materials Using Self-Assembled Block Copolymer Thin-Film for Nanodevices. Frontiers in Nanotechnology 3, (2021).
38. A. Subramanian, N. Tiwale, C.-Y. Nam, Review of Recent Advances in Applications of Vapor-Phase Material Infiltration Based on Atomic Layer Deposition. JOM 71, 185-196 (2019).
39. Y. Yu, Z. Li, Y. Wang, S. Gong, X. Wang, Sequential Infiltration Synthesis of Doped Polymer Films with Tunable Electrical Properties for Efficient Triboelectric Nanogenerator Development. Advanced Materials 27, 4938-4944 (2015).
40. A. Subramanian, N. Tiwale, W. I. Lee, K. Kisslinger, M. Lu, A. Stein, J. Kim, C. Y. Nam, Vapor-Phase Infiltrated Organic-Inorganic Positive-Tone Hybrid Photoresist for Extreme UV Lithography. Advanced Materials Interfaces, 2300420 (2023).
41. Y.-C. Tseng, Q. Peng, L. E. Ocola, D. A. Czaplewski, J. W. Elam, S. B. Darling, Enhanced polymeric lithography resists via sequential infiltration synthesis. Journal of Materials Chemistry 21, 11722-11725 (2011).
42. N. Tiwale, A. Subramanian, K. Kisslinger, M. Lu, J. Kim, A. Stein, C.-Y. Nam, Advancing next generation nanolithography with infiltration synthesis of hybrid nanocomposite resists. Journal of Materials Chemistry C 7, 8803-8812 (2019).
43. N. Tiwale, A. Subramanian, G. Freychet, E. Gann, K. Kisslinger, M. Lu, A. Stein, J. Kim, C.-Y. Nam, Hybrid resist synthesis by ex-situ vapor-phase infiltration of metal oxides into conventional organic resists (SPIE Advanced Lithography, SPIE, 2021), vol. 11612.
44. S. Greil, A. Rahman, M. Liu, C. T. Black, Gas Transport Selectivity of Ultrathin, Nanoporous, Inorganic Membranes Made from Block Copolymer Templates. Chemistry of Materials 29, 9572-9578 (2017).
45. K. J. Dusoe, X. Ye, K. Kisslinger, A. Stein, S.-W. Lee, C.-Y. Nam, Ultrahigh Elastic Strain Energy Storage in Metal-Oxide-Infiltrated Patterned Hybrid Polymer Nanocomposites. Nano Letters 17, 7416-7423 (2017).
46. M. Moshonov, G. L. Frey, Directing Hybrid Structures by Combining Self-Assembly of Functional Block Copolymers and Atomic Layer Deposition: A Demonstration on Hybrid Photovoltaics. Langmuir 31, 12762-12769 (2015).
47. E. Barry, A. U. Mane, J. A. Libera, J. W. Elam, S. B. Darling, Advanced oil sorbents using sequential infiltration synthesis. Journal of Materials Chemistry A 5, 2929-2935 (2017).
48. A. Subramanian, N. Tiwale, K. Kisslinger, C.-Y. Nam, Reduced Stochastic Resistive Switching in Organic-Inorganic Hybrid Memristors by Vapor-Phase Infiltration. Advanced Electronic Materials 8, 2200172 (2022).
49. C.-Y. Nam, A. Stein, K. Kisslinger, C. T. Black, Electrical and structural properties of ZnO synthesized via infiltration of lithographically defined polymer templates. Applied Physics Letters 107, 203106 (2015).
50. C.-Y. Nam, A. Stein, Extreme Carrier Depletion and Superlinear Photoconductivity in Ultrathin Parallel-Aligned ZnO Nanowire Array Photodetectors Fabricated by Infiltration Synthesis. Advanced Optical Materials 5, 1700807 (2017).
51. A. Subramanian, G. Doerk, K. Kisslinger, D. H. Yi, R. B. Grubbs, C. Y. Nam, Three-dimensional electroactive ZnO nanomesh directly derived from hierarchically self-assembled block copolymer thin films. Nanoscale 11, 9533-9546 (2019).
52. Y. She, E. D. Goodman, J. Lee, B. T. Diroll, M. Cargnello, E. V. Shevchenko, D. Berman, Block-Co-polymer-Assisted Synthesis of All Inorganic Highly Porous Heterostructures with Highly Accessible Thermally Stable Functional Centers. ACS Applied Materials & Interfaces 11, 30154-30162 (2019).
53. B. K. Barick, A. Simon, I. Weisbord, N. Shomrat, T. Segal-Peretz, Tin oxide nanostructure fabrication via sequential infiltration synthesis in block copolymer thin films. Journal of Colloid and Interface Science 557, 537-545 (2019).
54. D. Berman, E. Shevchenko, Design of functional composite and all-inorganic nanostructured materials via infiltration of polymer templates with inorganic precursors. Journal of Materials Chemistry C, (2020).
55. J. Chai, D. Wang, X. Fan, J. M. Buriak, Assembly of aligned linear metallic patterns on silicon. Nature Nanotechnology 2, 500 (2007).
56. C. Cummins, D. Borah, S. Rasappa, A. Chaudhari, T. Ghoshal, B. M. D. O'Driscoll, P. Carolan, N. Petkov, J. D. Holmes, M. A. Morris, Self-assembly of polystyrene-block-poly(4-vinylpyridine) block copolymer on molecularly functionalized silicon substrates: fabrication of inorganic nanostructured etchmask for lithographic use. Journal of Materials Chemistry C 1, 7941-7951 (2013).
57. C. Cummins, A. Gangnaik, R. A. Kelly, D. Borah, J. O'Connell, N. Petkov, Y. M. Georgiev, J. D. Holmes, M. A. Morris, Aligned silicon nanofins via the directed self-assembly of PS-b-P4VP block copolymer and metal oxide enhanced pattern transfer. Nanoscale 7, 6712-6721 (2015).
58. T. Ghoshal, A. Chaudhari, C. Cummins, M. T. Shaw, J. D. Holmes, M. A. Morris, Morphological evolution of lamellar forming polystyrene-block-poly(4-vinylpyridine) copolymers under solvent annealing. Soft Matter 12, 5429-5437 (2016).
59. D. O. Shin, J. H. Mun, G.-T. Hwang, J. M. Yoon, J. Y. Kim, J. M. Yun, Y.-B. Yang, Y. Oh, J. Y. Lee, J. Shin, K. J. Lee, S. Park, J. U. Kim, S. O. Kim, Multicomponent Nanopatterns by Directed Block Copolymer Self-Assembly. ACS Nano 7, 8899-8907 (2013).
60. W. Jo, K. J. Freedman, M. J. Kim, in 2012 38th Annual Northeast Bioengineering Conference (NEBEC). (2012), pp. 191-192.
61. Y. Tian, J. R. Lhermitte, L. Bai, T. Vo, H. L. Xin, H. Li, R. Li, M. Fukuto, K. G. Yager, J. S. Kahn, Y. Xiong, B. Minevich, S. K. Kumar, O. Gang, Ordered three-dimensional nanomaterials using DNA-prescribed and valence-controlled material voxels. Nat Mater, (2020).
62. A. Michelson, B. Minevich, H. Emamy, X. Huang, Y. S. Chu, H. Yan, O. Gang, Three-dimensional visualization of nanoparticle lattices and multimaterial frameworks. Science 376, 203-207 (2022).
63. A. V. Naumkin, A. Kraut-Vass, S. W. Gaarenstroom, C. J. Powell. (2012).
64. C. Z. Leng, M. D. Losego, Vapor phase infiltration (VPI) for transforming polymers into organic-inorganic hybrid materials: a critical review of current progress and future challenges. Materials Horizons 4, 747-771 (2017).
65. E. K. McGuinness, Y. Liu, R. Ramprasad, M. D. Losego, Quartz crystal microbalance gravimetry measurements of the sorption of trimethylaluminum into polystyrene and poly(methyl methacrylate). Materials Chemistry and Physics 294, 127026 (2023).
66. M. Rocklein, S. George, Temperature-induced apparent mass changes observed during quartz crystal microbalance measurements of atomic layer deposition. Analytical Chemistry 75, 4975-4982 (2003).
67. I. Weisbord, N. Shomrat, R. Azoulay, A. Kaushansky, T. Segal-Peretz, Understanding and Controlling Polymer-Organometallic Precursor Interactions in Sequential Infiltration Synthesis. Chemistry of Materials 32, 4499-4508 (2020).
68. C. Wilson, R. Grubbs, S. George, Nucleation and growth during Al2O3atomic layer deposition on polymers. Chemistry of Materials 17, 5625-5634 (2005).
69. L. Wang, Y. Zhou, Y. Yang, A. Subramanian, K. Kisslinger, X. Zuo, Y.-C. Chuang, Y. Yin, C.-Y. Nam, M. H. Rafailovich, Suppression of Carbon Monoxide Poisoning in Proton Exchange Membrane Fuel Cells via Gold Nanoparticle/Titania Ultrathin Film Heterogeneous Catalysts. ACS Applied Energy Materials 2, 3479-3487 (2019).
70. N. Tiwale, S. P. Senanayak, J. Rubio-Lara, Y. Alaverdyan, M. E. Welland, Optimization of transistor characteristics and charge transport in solution processed ZnO thin films grown from zinc neodecanoate. Electronic Materials Letters 15, 702-711 (2019).
71. N. Tiwale, S. P. Senanayak, J. Rubio-Lara, A. Prasad, A. Aziz, Y. Alaverdyan, M. E. Welland, Solution-Processed High-Performance ZnO Nano-FETs Fabricated with Direct-Write Electron-Beam-Lithography-Based Top-Down Route. Advanced Electronic Materials 7, 2000978 (2021).
72. W. Q. Han, W. Wen, D. Yi, Z. Liu, M. M. Maye, L. Lewis, J. Hanson, O. Gang, Fe-Doped trititanate nanotubes: Formation, optical and magnetic properties, and catalytic applications. Journal of Physical Chemistry C 111, 14339-14342 (2007).
73. H. Yan, Ptychographic phase retrieval by proximal algorithms. New Journal of Physics 22, 023035 (2020).
74. D. Kazantsev, N. Wadeson, in CT Meeting. (2020), vol. 2020.

What is claimed:

1. A composite, comprising:
a three-dimensional (3D) silicate lattice,
the silicate lattice comprising a first porous motif,
the first porous motif optionally being characterized as polyhedral,
the first porous motif optionally defining a pore size of from about 5 to about 100 nm; and
a first inorganic layer superposed over the silicate lattice,
the first inorganic layer optionally coupled to the silicate lattice.

2. The composite of claim 1, wherein the first porous motif is characterized as tetrahedral.

3. The composite of claim 1, wherein the first porous motif is characterized as octahedral.

4. The composite of claim 1, wherein the silicate lattice comprises a second porous motif.

5. The composite of claim 4, wherein the second porous motif is characterized as polyhedral.

6. The composite of claim 4, wherein the second porous motif defines at least one of (1) a pore size that differs from the pore size of the first porous motif and (2) a 3D structure that differs from the 3D structure of the first porous motif.

7. The composite of claim 1, wherein the first inorganic layer comprises any one or more of a metal and a metal oxide.

8. The composite of claim 7, wherein the metal comprises any one or more of aluminum, copper, gold, indium, molybdenum, platinum, tin, tungsten, and zinc.

9. The composite of claim 7, wherein the metal oxide comprises any one or more of AlOₓ and ZnOₓ.

10. The composite of claim 1, further comprising a nucleic acid frame on which the silicate lattice is superposed.

11. The composite of claim 1, further comprising a second inorganic layer, the second inorganic layer being superposed over the first inorganic layer.

12. A device, the device comprising the composite according to claim 1.

13. A method, comprising:
forming a silicate layer superposed on a 3D nucleic acid lattice,
the 3D nucleic acid lattice comprising a first porous motif,
the first porous motif optionally being characterized as polyhedral,
the first porous motif optionally defining a pore size of from about 5 to about 100 nm; and
forming a first inorganic layer superposed over the silicate layer,
the first inorganic layer optionally coupled to the silicate layer.

14. The method of claim 13, wherein the first porous motif is characterized as tetrahedral or octahedral.

15. The method of claim 13, wherein the 3D nucleic acid lattice comprises a second porous motif, wherein the second porous motif defines at least one of (1) a pore size that differs from the pore size of the first porous motif and (2) a 3D structure that differs from the 3D structure of the first porous motif.

16. The method of claim 13, wherein forming the first inorganic layer comprises any one or more of a vapor phase infiltration and a liquid phase infiltration.

17. The method of claim 13, wherein the first inorganic layer comprises any one or more of a metal and a metal oxide.

18. The method of claim 17, wherein the metal comprises any one or more of Al, Au, Cu, In, Mo Pt, Sn, W, and Zn.

19. The method of claim 17, wherein the metal oxide comprises any one or more of AlOₓ and ZnOₓ.

20. The method of claim 13, further comprising forming a second inorganic layer superposed over the first inorganic layer.
